(19) United States
(12) Patent Application Publication
(10) Pub. No.: US 2026/0313623 A1
(43) Pub. Date: Oct. 8, 2026

(54) FREQUENCY DOMAIN RESOURCE ALLOCATION FOR A RANDOM ACCESS MESSAGE IN SUB-BAND FULL-DUPLEX SCENARIOS

(71) Applicant: QUALCOMM Incorporated, San Diego, CA (US)

(72) Inventors: Mohammed JABI, San Diego, CA (US); Muhammad Sayed Khairy ABDELGHAFFAR, San Jose, CA (US); Ahmed Attia ABOTABL, San Diego, CA (US); Abdelrahman Mohamed IBRAHIM, San Diego, CA (US)

(21) Appl. No.: 19/172,123

(22) Filed: Apr. 7, 2025

(51) Int. Cl. H04W 72/0453; H04L 5/14; H04W 74/0833

(52) U.S. Cl. CPC H04W 72/0453; H04L 5/14; H04W 74/0833

(57) ABSTRACT

Various aspects of the present disclosure generally relate to wireless communication. In some aspects, a network entity may receive first configuration information indicating a sub-band that includes one or more first frequency domain resources. The network entity may receive second configuration information indicating an active bandwidth part (BWP) that includes one or more second frequency domain resources. The network entity may receive an indication of a frequency domain resource allocation, wherein the frequency domain resource allocation is included in the one or more second frequency domain resources, wherein the frequency domain resource allocation is based on frequency domain numbering starting from a starting frequency domain resource that is based on the one or more first frequency domain resources or the one or more second frequency domain resources. The network entity may transmit, using the frequency domain resource allocation, the random access message. Numerous other aspects are described.

### FIELD OF THE DISCLOSURE

Aspects of the present disclosure generally relate to wireless communication and specifically relate to techniques, apparatuses, and methods associated with frequency domain resource allocation for a random access message in sub-band full-duplex scenarios.

### INTRODUCTION

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a network entity. The network entity may include a processing system. The processing system may be configured to receive first configuration information indicating a sub-band for sub-band full-duplex (SBFD) time intervals, wherein the sub-band includes one or more first frequency domain resources. The processing system may be configured to receive second configuration information indicating a bandwidth part (BWP), wherein the BWP includes one or more second frequency domain resources, and wherein the one or more second frequency domain resources are included in the one or more first frequency domain resources based on configuration of the first configuration information. The processing system may be configured to receive an indication of a frequency domain resource allocation for a random access message, wherein the frequency domain resource allocation is based on at least one of the sub-band or the BWP. The processing system may be configured to transmit, using the frequency domain resource allocation, the random access message.

Some aspects described herein relate to a network entity. The network entity may include a processing system. The processing system may be configured to transmit first configuration information indicating a sub-band for SBFD time intervals, wherein the sub-band includes one or more first frequency domain resources. The processing system may be configured to transmit second configuration information indicating a BWP, wherein the BWP includes one or more second frequency domain resources, and wherein the one or more second frequency domain resources are included in the one or more first frequency domain resources based on configuration of the first configuration information. The processing system may be configured to transmit an indication of a frequency domain resource allocation for a random access message, wherein the frequency domain resource allocation is based on at least one of the sub-band or the BWP. The processing system may be configured to receive, using the frequency domain resource allocation, the random access message.

Some aspects described herein relate to a method of wireless communication performed by a network entity. The method may include receiving first configuration information indicating a sub-band for SBFD time intervals, wherein the sub-band includes one or more first frequency domain resources. The method may include receiving second configuration information indicating a BWP, wherein the BWP includes one or more second frequency domain resources, and wherein the one or more second frequency domain resources are included in the one or more first frequency domain resources based on configuration of the first configuration information. The method may include receiving an indication of a frequency domain resource allocation for a random access message, wherein the frequency domain resource allocation is based on at least one of the sub-band or the BWP. The method may include transmitting, using the frequency domain resource allocation, the random access message.

Some aspects described herein relate to a method of wireless communication performed by a network entity. The method may include transmitting first configuration information indicating a sub-band for SBFD time intervals, wherein the sub-band includes one or more first frequency domain resources. The method may include transmitting second configuration information indicating a BWP, wherein the BWP includes one or more second frequency domain resources, and wherein the one or more second frequency domain resources are included in the one or more first frequency domain resources based on configuration of the first configuration information. The method may include transmitting an indication of a frequency domain resource allocation for a random access message, wherein the frequency domain resource allocation is based on at least one of the sub-band or the BWP. The method may include receiving, using the frequency domain resource allocation, the random access message.

Some aspects described herein relate to a non-transitory computer-readable medium having code stored thereon. The code, when executed by a network entity, may cause the network entity to receive first configuration information indicating a sub-band for SBFD time intervals, wherein the sub-band includes one or more first frequency domain resources. The code, when executed by a network entity, may cause the network entity to receive second configuration information indicating a BWP, wherein the BWP includes one or more second frequency domain resources, and wherein the one or more second frequency domain resources are included in the one or more first frequency domain resources based on configuration of the first configuration information. The code, when executed by a network entity, may cause the network entity to receive an indication of a frequency domain resource allocation for a random access message, wherein the frequency domain resource allocation is based on at least one of the sub-band or the BWP. The code, when executed by a network entity, may cause the network entity to transmit, using the frequency domain resource allocation, the random access message.

Some aspects described herein relate to a non-transitory computer-readable medium having code stored thereon. The code, when executed by a network entity, may cause the network entity to transmit first configuration information indicating a sub-band for SBFD time intervals, wherein the sub-band includes one or more first frequency domain resources. The code, when executed by a network entity, may cause the network entity to transmit second configuration information indicating a BWP, wherein the BWP includes one or more second frequency domain resources, and wherein the one or more second frequency domain resources are included in the one or more first frequency domain resources based on configuration of the first configuration information. The code, when executed by a network entity, may cause the network entity to transmit an indication of a frequency domain resource allocation for a random access message, wherein the frequency domain resource allocation is based on at least one of the sub-band or the BWP. The code, when executed by a network entity, may cause the network entity to receive, using the frequency domain resource allocation, the random access message.

Some aspects described herein relate to an apparatus for wireless communication. The apparatus may include means for receiving first configuration information indicating a sub-band for SBFD time intervals, wherein the sub-band includes one or more first frequency domain resources. The apparatus may include means for receiving second configuration information indicating a BWP, wherein the BWP includes one or more second frequency domain resources, and wherein the one or more second frequency domain resources are included in the one or more first frequency domain resources based on configuration of the first configuration information. The apparatus may include means for receiving an indication of a frequency domain resource allocation for a random access message, wherein the frequency domain resource allocation is based on at least one of the sub-band or the BWP. The apparatus may include means for transmitting, using the frequency domain resource allocation, the random access message.

Some aspects described herein relate to an apparatus for wireless communication. The apparatus may include means for transmitting first configuration information indicating a sub-band for SBFD time intervals, wherein the sub-band includes one or more first frequency domain resources. The apparatus may include means for transmitting second configuration information indicating a BWP, wherein the BWP includes one or more second frequency domain resources, and wherein the one or more second frequency domain resources are included in the one or more first frequency domain resources based on configuration of the first configuration information. The apparatus may include means for transmitting an indication of a frequency domain resource allocation for a random access message, wherein the frequency domain resource allocation is based on at least one of the sub-band or the BWP. The apparatus may include means for receiving, using the frequency domain resource allocation, the random access message.

Some aspects described herein relate to a network entity. The network entity may include a processing system. The processing system may be configured to receive first configuration information indicating a sub-band for SBFD time intervals, wherein the sub-band includes one or more first frequency domain resources. The processing system may be configured to receive second configuration information indicating an active BWP, wherein the active BWP includes one or more second frequency domain resources. The processing system may be configured to receive an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources. The processing system may be configured to transmit, using the frequency domain resource allocation, the random access message.

Some aspects described herein relate to a network entity. The network entity may include a processing system. The processing system may be configured to transmit first configuration information indicating a sub-band for SBFD time intervals, wherein the sub-band includes one or more first frequency domain resources. The processing system may be configured to transmit second configuration information indicating an active BWP, wherein the active BWP includes one or more second frequency domain resources. The processing system may be configured to transmit an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources. The processing system may be configured to receive, using the frequency domain resource allocation, the random access message.

Some aspects described herein relate to a method of wireless communication performed by a network entity. The method may include receiving first configuration information indicating a sub-band for SBFD time intervals, wherein the sub-band includes one or more first frequency domain resources. The method may include receiving second configuration information indicating a BWP, wherein the BWP includes one or more second frequency domain resources, and wherein the one or more second frequency domain resources are included in the one or more first frequency domain resources based on configuration of the first configuration information. The method may include receiving an indication of a frequency domain resource allocation for a random access message, wherein the frequency domain resource allocation is based on at least one of the sub-band or the BWP. The method may include transmitting, using the frequency domain resource allocation, the random access message.

Some aspects described herein relate to a method of wireless communication performed by a network entity. The method may include transmitting first configuration information indicating a sub-band for SBFD time intervals, wherein the sub-band includes one or more first frequency domain resources. The method may include transmitting second configuration information indicating a BWP, wherein the BWP includes one or more second frequency domain resources, and wherein the one or more second frequency domain resources are included in the one or more first frequency domain resources based on configuration of the first configuration information. The method may include transmitting an indication of a frequency domain resource allocation for a random access message, wherein the frequency domain resource allocation is based on at least one of the sub-band or the BWP. The method may include receiving, using the frequency domain resource allocation, the random access message.

Some aspects described herein relate to a non-transitory computer-readable medium having code stored thereon. The code, when executed by a network entity, may cause the network entity to receive first configuration information indicating a sub-band for SBFD time intervals, wherein the sub-band includes one or more first frequency domain resources. The code, when executed by a network entity, may cause the network entity to receive second configuration information indicating a BWP, wherein the BWP includes one or more second frequency domain resources, and wherein the one or more second frequency domain resources are included in the one or more first frequency domain resources based on configuration of the first configuration information. The code, when executed by a network entity, may cause the network entity to receive an indication of a frequency domain resource allocation for a random access message, wherein the frequency domain resource allocation is based on at least one of the sub-band or the BWP. The code, when executed by a network entity, may cause the network entity to transmit, using the frequency domain resource allocation, the random access message.

Some aspects described herein relate to a non-transitory computer-readable medium having code stored thereon. The code, when executed by a network entity, may cause the network entity to transmit first configuration information indicating a sub-band for SBFD time intervals, wherein the sub-band includes one or more first frequency domain resources. The code, when executed by a network entity, may cause the network entity to transmit second configuration information indicating a BWP, wherein the BWP includes one or more second frequency domain resources, and wherein the one or more second frequency domain resources are included in the one or more first frequency domain resources based on configuration of the first configuration information. The code, when executed by a network entity, may cause the network entity to transmit an indication of a frequency domain resource allocation for a random access message, wherein the frequency domain resource allocation is based on at least one of the sub-band or the BWP. The code, when executed by a network entity, may cause the network entity to receive, using the frequency domain resource allocation, the random access message.

Some aspects described herein relate to an apparatus for wireless communication. The apparatus may include means for receiving first configuration information indicating a sub-band for SBFD time intervals, wherein the sub-band includes one or more first frequency domain resources. The apparatus may include means for receiving second configuration information indicating a BWP, wherein the BWP includes one or more second frequency domain resources, and wherein the one or more second frequency domain resources are included in the one or more first frequency domain resources based on configuration of the first configuration information. The apparatus may include means for receiving an indication of a frequency domain resource allocation for a random access message, wherein the frequency domain resource allocation is based on at least one of the sub-band or the BWP. The apparatus may include means for transmitting, using the frequency domain resource allocation, the random access message.

Some aspects described herein relate to an apparatus for wireless communication. The apparatus may include means for transmitting first configuration information indicating a sub-band for SBFD time intervals, wherein the sub-band includes one or more first frequency domain resources. The apparatus may include means for transmitting second configuration information indicating a BWP, wherein the BWP includes one or more second frequency domain resources, and wherein the one or more second frequency domain resources are included in the one or more first frequency domain resources based on configuration of the first configuration information. The apparatus may include means for transmitting an indication of a frequency domain resource allocation for a random access message, wherein the frequency domain resource allocation is based on at least one of the sub-band or the BWP. The apparatus may include means for receiving, using the frequency domain resource allocation, the random access message.

Aspects generally include a method, apparatus, system, computer program product, non-transitory computer-readable medium, user equipment, base station, network entity, network node, wireless communication device, or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

FIG. 1 is a diagram illustrating an example environment in which apparatuses or methods described herein may be implemented.

FIG. 2 is a diagram illustrating an example of a wireless communication network.

FIG. 3 is a diagram illustrating an example of a four-step random access procedure.

FIG. 4 is a diagram illustrating an example of sub-band full duplex (SBFD) operation.

FIG. 5 is a diagram illustrating an example of initial bandwidth parts (BWPs) in SBFD scenarios.

FIG. 6 is a diagram of an example associated with a frequency domain resource allocation for a random access message in SBFD scenarios.

FIG. 7 is a diagram of an example associated with a restriction of an initial BWP in SBFD scenarios.

FIGS. 8A and 8B are diagrams of an example associated with frequency domain numbering for frequency domain resource allocations (FDRAs) in SBFD scenarios.

FIG. 9 is a diagram of an example associated with FDRAs in association with an active BWP in SBFD scenarios.

FIG. 10 is a diagram illustrating an example process performed, for example, at a network entity or an apparatus of a network entity.

FIG. 11 is a diagram illustrating an example process performed, for example, at a network entity or an apparatus of a network entity.

FIG. 12 is a diagram illustrating an example process performed, for example, at a network entity or an apparatus of a network entity.

FIG. 13 is a diagram illustrating an example process performed, for example, at a network entity or an apparatus of a network entity.

FIG. 14 is a diagram of an example apparatus for wireless communication.

FIG. 15 is a diagram of an example apparatus for wireless communication.

### DETAILED DESCRIPTION

A first network entity (such as a user equipment (UE)) in some wireless communication systems may perform one or more procedures for establishing a communications link with a second network entity (such as a network node) that is operating as part of a wireless communication network. The first network entity may communicate a series of messages with the second network entity to establish access to the network. In some examples, establishing access to the network may be referred to as initial access. In some examples, the first network entity may perform a random access procedure to establish access to the wireless communication network via the second network entity (e.g., to establish a communication connection including an uplink connection or a downlink connection). In some examples, the random access procedure may also be referred to as a random access channel (RACH) procedure. In some examples, the first network entity may perform a random access procedure, such as a four-step random access procedure or a two-step random access procedure. In some examples, the first network entity may perform a random access procedure (e.g., a RACH procedure) with a second network entity to enable the first network entity to establish a connection with the second network entity, such as for an initial access, a link recovery, or a beam failure recovery, among other examples.

As part of a four-step random access procedure, the first network entity may transmit, and the second network entity may receive, a first message (msg1) via a physical random access channel (PRACH). The msg1 may include a PRACH preamble. The first network entity may receive, and the second network entity may transmit, a second message (msg2) via a physical downlink control channel (PDCCH) or via a physical downlink shared channel (PDSCH) based on transmitting the msg1. The msg2 may include a random access response (RAR) message that schedules a physical uplink shared channel (PUSCH) transmission by the first network entity. For example, the msg2 may indicate or allocate uplink resources via which the first network entity may transmit a PUSCH message. The first network entity may transmit, and the second network entity may receive, a third message (msg3) including the PUSCH message or the first network entity may transmit, and the second network entity may receive, the msg3 via the PUSCH resources. The first network entity may receive, and the second network entity may transmit, a fourth message (msg4) that includes a contention resolution message via the PDCCH or PDSCH. For example, the first network entity may analyze the contention resolution message to identify whether the msg4 includes identification information (e.g., a radio network temporary identifier) that matches with the identification information of the first network entity (e.g., as opposed to identification information associated with a different first network entity). If the msg4 includes identification information associated with the first network entity, the first network entity may proceed with establishing the connection. Otherwise, the first network entity may restart the four-step random access procedure, for example, by retransmitting the msg1 or transmitting a second msg1.

In some examples, the second network entity may transmit, and the first network entity may receive, a frequency domain resource allocation (FDRA) for one or more random access messages, such as the msg3. In some examples, the FDRA may be indicated based on, or in accordance with, a bandwidth part (BWP) configuration. For example, the FDRA may be within a range of frequency domain resources (e.g., a range of resource blocks (RBs)). For example, the range of the frequency domain resources may include all frequency domain resources of an initial uplink BWP (e.g., if the active uplink BWP and the initial uplink BWP have the same subcarrier spacing and cyclic prefix length and the active uplink BWP includes all RBs of the initial uplink BWP, or if the active uplink BWP is the initial uplink BWP). In such examples, frequency domain numbering (e.g., for indicating the frequency domain resource allocation) may start at a first RB of the initial uplink BWP and end at a last RB of the initial uplink BWP. In other examples, the frequency domain numbering may start at a first RB of the active uplink BWP and a maximum quantity of RBs included in the frequency domain resource allocation may be the quantity of RBs in the initial uplink BWP. Additionally, the first network entity may determine (e.g., interpret or process) an indication of the FDRA based on a size of a configured BWP (e.g., for truncation or expansion operations).

In some examples, the first network entity and the second network entity may perform a random access procedure when a sub-band full-duplex (SBFD) configuration is configured (e.g., when the second network entity is operating in accordance with the SBFD configuration). For example, the SBFD configuration may enable a network node to concurrently transmit downlink messages and receive uplink messages within the same time slot, but in different frequency sub-bands. The SBFD configuration may include one or more SBFD time intervals and one or more non-SBFD time intervals (e.g., one or more downlink time intervals, uplink time intervals, or flexible time intervals). For example, SBFD time intervals may be associated with a frequency band that includes an uplink frequency sub-band allocated for UE transmissions and includes one or more downlink frequency sub-bands allocated for network transmissions. The non-SBFD time intervals may include time intervals where the frequency band is associated with either downlink or uplink (e.g., but not both). For example, “downlink time intervals” may refer to time intervals where the frequency band is configured with downlink resources to enable downlink transmissions, and “uplink time intervals” may refer to time intervals where the frequency band is configured with uplink resources to enable uplink transmissions. Additionally, flexible time intervals may allow dynamic switching between uplink and downlink transmission modes based on network scheduling decisions (e.g., adapting to traffic demand and interference conditions). For example, the network node may dynamically configure a flexible time interval to be either an uplink time interval or a downlink time interval. In some examples, the term “time interval” as used herein may refer to one or more symbols, one or more mini-slots, one or more sub-slots, or one or more slots.

However, current mechanisms for FDRAs for random access messages (such as msg3) do not account for SBFD configurations. This may result in conflicts or inefficient resource utilization for SBFD time intervals. For example, uplink scheduling during SBFD time intervals may be restricted to one or more usable frequency domain resources. In this context, “usable” frequency domain resource may refer to a resource that is included in both an active uplink BWP and an uplink sub-band (e.g., as indicated by the SBFD configuration). As frequency domain numbering for FDRAs for random access messages (such as msg3) may start at a first RB of an initial uplink BWP or an active BWP, this may result in SBFD time intervals being unusable for scheduling the random access messages (such as msg3). For example, the initial uplink BWP or the active BWP may not overlap in the frequency domain with an uplink sub-band configured by the SBFD configuration. In some examples, center frequencies of an active uplink BWP and an active downlink BWP may be aligned (e.g., may be the same frequency). Therefore, the second network entity (e.g., a network node) may configure a larger active uplink BWP and a larger active downlink BWP so that a frequency range of the active uplink BWP and the active downlink BWP includes at least a portion of an uplink sub-band. This may consume network resources associated with using larger BWPs for communication. Alternatively, there may be an increased likelihood of the initial uplink BWP or the active BWP not overlapping in the frequency domain with an uplink sub-band configured by the SBFD configuration, resulting in the second network entity (e.g., a network node) being unable to schedule random access messages (such as msg) during SBFD time intervals. This may increase latency associated with the random access messages or result in inefficient resource utilization, among other examples.

Various aspects relate generally to FDRAs for a random access message in SBFD scenarios. Some aspects more specifically relate to an FDRA for a random access message (e.g., a msg3) being based on a BWP or on a sub-band (e.g., an uplink sub-band) configured via an SBFD configuration. In such examples, an initial BWP (e.g., the BWP) may be configured within the sub-band (e.g., the initial uplink BWP may be configured within an uplink sub-band configured via an SBFD configuration). In some examples, the FDRA may be associated with the BWP or on the sub-band. For example, the FDRA may be based on the BWP or on the sub-band. The FDRA may be based on the BWP or on the sub-band in that a frequency domain numbering or a range of values for the FDRA may be indicated by frequency domain resources of the BWP or the sub-band. For example, a starting frequency domain resource (e.g., a starting RB) for the frequency domain numbering may be a first frequency resource included in the BWP or the sub-band. As another example, a quantity of frequency domain resources (e.g., a range of RBs) for the frequency domain numbers may be a quantity of frequency domain resources included in the BWP or the sub-band.

Particular aspects of the subject matter described in this disclosure can be implemented to realize one or more of the following technical advantages. By a network entity using a frequency domain resource allocation that is based on the sub-band or the BWP, the described techniques can be used to manage random access message scheduling in both SBFD and non-SBFD time intervals, improving the utilization of available frequency resources. For example, because a network entity (e.g., a network node) may configure the initial BWP (e.g., the initial uplink BWP) within the frequency resources of the sub-band of an SBFD configuration (e.g., an uplink sub-band), the frequency domain numbering for the FDRA may include frequency domain resources included in the sub-band. As a result, the network entity (e.g., a network node) may schedule a random access message to occur during an SBFD time interval (e.g., using a subset of frequency domain resources include in the sub-band). In some aspects, by the network entity using an FDRA that is based on the BWP, the scheduling mechanisms for the random access messages may align with non-SBFD operation, thereby reducing complexity associated with the integration of SBFD operation. In some other aspects, by the network entity using an FDRA that is based on the sub-band, the scheduling mechanisms for the random access messages may better align with the SBFD configuration, thereby improving the likelihood that a frequency domain numbering for the FDRA corresponds to the frequency resources of the sub-band. This alignment can facilitate more effective management of transmissions within the SBFD framework.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence devices). Aspects may be implemented in chip-level components, modular components, non-modular components, non-chip-level components, device-level components, or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, or summers). Aspects described herein may be practiced in a wide variety of devices, components, systems, distributed arrangements, or end-user devices of varying size, shape, and constitution.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

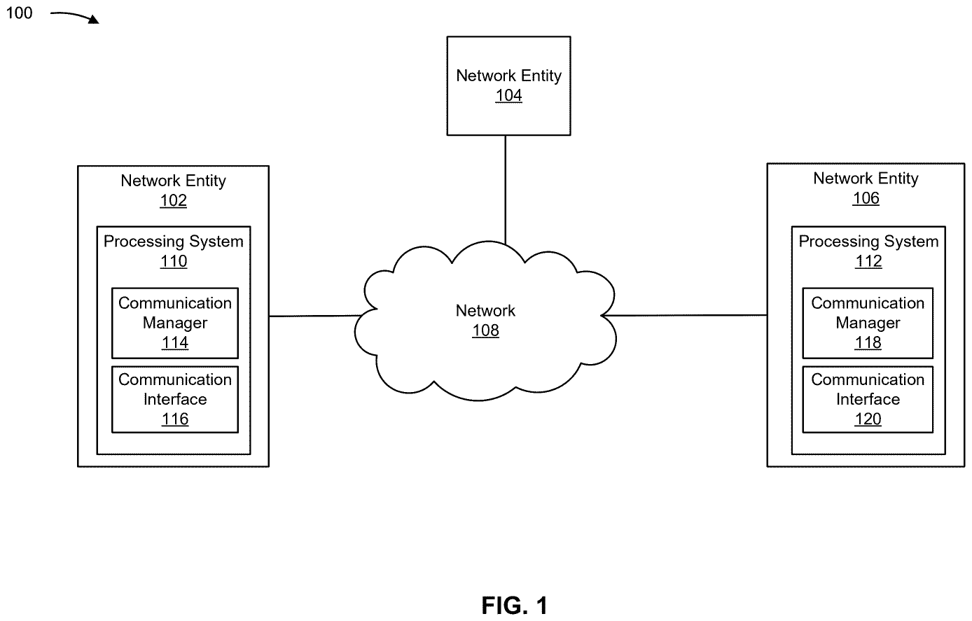

FIG. 1 is a diagram illustrating an example environment 100 in which apparatuses or methods described herein may be implemented. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary or mobile. The network 108 may include wired communication connections, wireless communication connections, or a combination of wired and wireless communication connections.

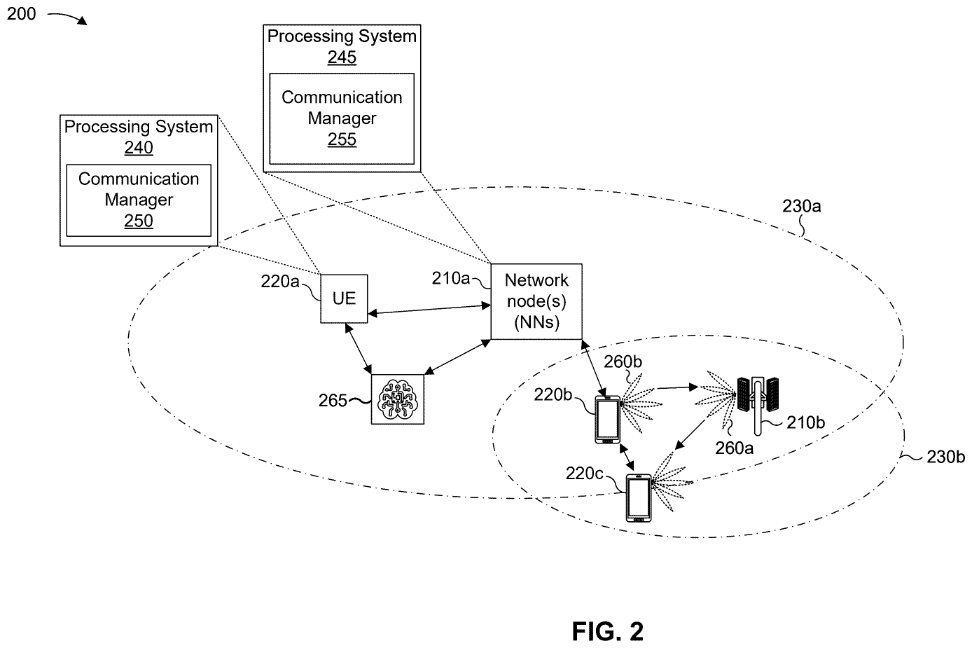

The network 108 may include, for example, a cellular network (e.g., a Long-Term Evolution (LTE) network, a CDMA network, a 4G network, a 5G network, a 6G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient IoT device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in or currently operating in the network. Rather, a network entity may be any entity that is capable of communicating or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, or a second processing entity, among other examples.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, or a third component configured to provide the output information to other systems or components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a processing system may include at least one memory, at least one communication interface, or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, or a third component configured to output the one or more outputs to one or more other components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, or a transceiver, among other examples. For example, a communication interface may include one or more transceivers, one or more receivers, or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, or a modulation component, among other examples.

A communication interface may include a transmission component or a reception component. For example, a communication interface may include a transceiver or one or more separate receivers or transmitters that enable a network entity to communicate with other devices, such as via a wired connection, a wireless connection, or a combination of wired and wireless connections. In some examples, a communication interface may include one or more radio frequency reflective elements or one or more radio frequency refractive elements. The communication interface may enable the network entity to receive information from another apparatus or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), or a serial peripheral interface (SPI), among other examples.

As described herein, a network entity (e.g., the network entity 102 or the network entity 106) may be configured to perform one or more operations. Reference to a network entity being configured to perform one or more operations may refer to a processing system of the network entity being configured to perform the one or more operations or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, or at least one communication interface, among other examples, that are configured to perform one or more (or all) of the one or more operations, or any combination thereof. Where reference is made to the network entity or the processing system being configured to perform operations, the network entity or the processing system may be configured to cause one component to perform all operations, or to cause more than one component to collectively perform the operations. When the network entity or the processing system is configured to cause more than one component to collectively perform the operations, each operation need not be performed by each of those components (e.g., different operations may be performed by different components) or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 or the communication interface 116 to) receive first configuration information indicating a sub-band for SBFD time intervals, wherein the sub-band includes one or more first frequency domain resources; receive second configuration information indicating a BWP, wherein the BWP includes one or more second frequency domain resources, and wherein the one or more second frequency domain resources are included in the one or more first frequency domain resources based on configuration of the first configuration information; receive an indication of a frequency domain resource allocation for a random access message, wherein the frequency domain resource allocation is based on at least one of the sub-band or the BWP; and transmit, using the frequency domain resource allocation, the random access message. Additionally, or alternatively, the network entity 102 or the communication manager 114 may perform one or more other operations described herein.

As described in more detail elsewhere herein, the network entity 102 may (e.g., the processing system 110 may, or the processing system 110 may cause the communication manager 114 or the communication interface 116 to) receive first configuration information indicating a sub-band for SBFD time intervals, wherein the sub-band includes one or more first frequency domain resources; receive second configuration information indicating an active BWP, wherein the active BWP includes one or more second frequency domain resources; receive an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; and transmit, using the frequency domain resource allocation, the random access message. Additionally, or alternatively, the network entity 102 or the communication manager 114 may perform one or more other operations described herein.

As described in more detail elsewhere herein, the network entity 106 may (e.g., the processing system 112 may, or the processing system 112 may cause the communication manager 118 or the communication interface 120 to) transmit first configuration information indicating a sub-band for SBFD time intervals, wherein the sub-band includes one or more first frequency domain resources; transmit second configuration information indicating a BWP, wherein the BWP includes one or more second frequency domain resources, and wherein the one or more second frequency domain resources are included in the one or more first frequency domain resources based on configuration of the first configuration information; transmit an indication of a frequency domain resource allocation for a random access message, wherein the frequency domain resource allocation is based on at least one of the sub-band or the BWP; and receive, using the frequency domain resource allocation, the random access message. Additionally, or alternatively, the network entity 106 or the communication manager 118 may perform one or more other operations described herein.

As described in more detail elsewhere herein, the network entity 106 may (e.g., the processing system 112 may, or the processing system 112 may cause the communication manager 118 or the communication interface 120 to) transmit first configuration information indicating a sub-band for SBFD time intervals, wherein the sub-band includes one or more first frequency domain resources; transmit second configuration information indicating an active BWP, wherein the active BWP includes one or more second frequency domain resources; transmit an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; and receive, using the frequency domain resource allocation, the random access message. Additionally, or alternatively, the network entity 106 or the communication manager 118 may perform one or more other operations described herein.

The number and arrangement of entities shown in FIG. 1 are provided as one or more examples. In practice, there may be additional network entities or networks, fewer network entities or networks, different network entities or networks, or differently arranged network entities or networks than those shown in FIG. 1. Furthermore, the network entity 102, 104, and 106 may be implemented using a single apparatus or multiple apparatuses.

FIG. 2 is a diagram illustrating an example of a wireless communication network 200. The wireless communication network 200 may be or may include elements of a 5G network or a 6G network, among other examples. The wireless communication network 200 may include multiple network nodes 210. For example, in FIG. 2, the wireless communication network 200 includes multiple network nodes 210, including a network node 210a and a network node 210b (each of which also may be referred to herein simply as a “network node 210”). The network nodes 210 may support communications with multiple UEs 220. For example, in FIG. 2, the network nodes 210 support communication with a UE 220a, a UE 220b, and a UE 220c (each of which also may be referred to herein simply as a “UE 220”). In some examples, a UE 220 also may communicate with other UEs 220 and a network node 210 also may communicate with a core network and with other network nodes 210. A network node 210 and a UE 220 may be examples of a network entity described herein, such as the network entity 102, the network entity 104, or the network entity 106.

The network nodes 210 and the UEs 220 of the wireless communication network 200 communicate using the electromagnetic spectrum, which may be subdivided into various licensed or unlicensed operating bands, frequency ranges, component carriers, or channels that define associated frequencies available for communications. In some examples, each of the network nodes 210 and the UEs 220 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 210 or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system. As shown in FIG. 2, each UE 220 includes a processing system 240 and each network node 210 includes a processing system 245. A processing system (for example, the processing system 240 or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 or the processing system 245 may include or implement one or more of the modems. The processing system 240 and the processing system 245 also may include or be coupled with multiple radios (collectively “the radio”), multiple RF chains, or multiple transceivers, each of which may in turn be coupled with one or more of multiple antennas. In some examples, one or more processors of the processing system 240 or the processing system 245 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 240 or by the processing system 245).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 210 and the UE 220.

A network node 210 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may include a single standalone base station or a single TRP that operates with a full radio protocol stack to enable or facilitate communication between a UE 220 and a core network of the wireless communication network 200.

Alternatively, and as also shown, a network node 210 may be a disaggregated network node 210 (sometimes referred to as a disaggregated base station), having a disaggregated architecture, meaning that the network node 210 may operate with a radio protocol stack that is physically distributed or logically distributed among two or more nodes in the same geographic location or in different geographic locations. In some deployments, disaggregated network nodes 210 may be used in an IAB network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. A CU may communicate with one or more DUs via respective midhaul links, such as via F1 interfaces. Each of the DUs may communicate with one or more RUs via respective fronthaul links. Each of the RUs may communicate with one or more UEs 220 via respective RF access links. In some deployments, a UE 220 may be simultaneously served by multiple RUs.

In some examples, a single network node 210 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 200 may be a heterogeneous network that includes network nodes 210 of various types. Different types of network nodes 210 may generally operate on the same or different operating bands, transmit at different power levels, or serve different coverage areas, each of which may be referred to as or associated with a particular cell 230 (for example, a cell 230a and a cell 230b).

The UEs 220 may be physically dispersed throughout the coverage area of the wireless communication network 200, and each UE 220 may be stationary or mobile. A UE 220 may be, may include, or also may be referred to as an access terminal, a mobile station, a client device, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 200.

Some UEs 220 may be classified according to different categories in association with different complexities or different capabilities. UEs 220 in a first category may be associated with relatively low complexity or cost such as NB-IoT devices or eMTC UEs. UEs 220 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 200. A third category of UEs 220 may have mid-tier complexity or capabilities (for example, capabilities between that of the UEs 220 of the first category and the UEs 220 of the second category). A UE 220 of the third category may be referred to as a reduced capability UE (“RedCap UE”), a mid-tier UE, an NR-Light UE, or an NR-Lite UE, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of RBs within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) or reconfigured (for example, in real-time or near-real-time) according to changing network conditions in the wireless communication network 200 or specific requirements of one or more UEs 220. An active BWP defines the operating bandwidth of the UE 220 within the operating bandwidth of the serving cell.

As indicated above, a BWP may be configured as a subset or a part of a total or full component carrier bandwidth and generally forms or encompasses a set of contiguous RBs within the full component carrier bandwidth. In other words, within the carrier bandwidth, a BWP starts at a specifically configured RB and may span a specific set of consecutive RBs. Each BWP may be associated with its own numerology (indicating an SCS and CP). In some examples, a UE 220 may be configured with up to four downlink BWPs and up to four uplink BWPs for each serving cell. To reduce UE power consumption, only one BWP in the downlink and one BWP in the uplink are generally active at a given time on an active serving cell under typical operation. The active BWP defines the operating bandwidth of the UE 220 within the operating bandwidth of the serving cell while all other BWPs with which the UE 220 is configured are deactivated. On deactivated BWPs, the UE 220 does not transmit or receive any communications.

A BWP may be an initial BWP (for example, an initial uplink BWP or an initial downlink BWP), a first active BWP, or a default BWP, among other examples. An initial BWP may be used by a UE 220 for initial access (for example, for a random access procedure), synchronization, or channel estimation, among other examples. A first active BWP may be a BWP that is to be active for the UE 220 after initial access is completed. A default BWP may be a BWP that the UE switches to based on, or otherwise associated with, detecting no activity on an active BWP for a given amount of time (for example, where the given amount of time is based on a configured BWP inactivity timer). In some examples, the UE 220 may switch between an active BWP and another BWP (for example, an inactive BWP or the default BWP). This may be referred to as BWP switching. In some examples, the UE 220 may switch BWPs based on, or otherwise associated with, receiving an indication to switch the active BWP (for example, where the indication is included in DCI or an RRC message from a network node 210). As another example, the UE 220 may switch BWPs based on, or otherwise associated with, detecting no activity on an active BWP for a given amount of time (for example, where the given amount of time is based on a configured BWP inactivity timer). As another example, the UE 220 may switch BWPs based on, or otherwise associated with, performing a given operation or procedure. For example, the UE 220 may switch to an initial BWP based on, or otherwise associated with, performing a random access procedure.

In some examples, a UE 220 may perform a random access procedure (e.g., a RACH procedure) with a network node 210 to enable the UE 220 to establish a connection with the network node, such as for an initial access, a link recovery, or a beam failure recovery, among other examples. The RACH procedure may include the exchange of one or more random access messages between the UE and the network node. For example, the UE may transmit a preamble, such as a PRACH preamble. In some examples, the UE 220 may utilize resources that are configured (such as via system information signaling) for initiating random access procedures with the network node 210. As part of the random access procedure, the UE 220 may transmit a random access message (RAM) that includes the preamble. The UE 220 may transmit the RAM via a RACH. The network node 210 may transmit, and the UE 220 may receive, an RAR. The UE 220 can use the RAR to perform synchronization and establish a communication connection with the network node. A random access procedure may include a two-step random access procedure, a three-step random access procedure, a four-step random access procedure, or another type of random access procedure. The random access procedure may enable the network node to manage network resources efficiently by ensuring that multiple UEs 220 can simultaneously and reliably request access to the wireless communication network, such as in dense environments or deployments.

Advancements in random access procedures may enable enhanced efficiency, reduced latency, scalability, or performance, among other examples, in the wireless communication network 200. For example, the UE 220 and the network node 210 may perform a beam refinement operation during the random access procedure to improve the quality of an initial connection between the UE 220 and the network node 210, such as by the UE 220 transmitting channel state information for one or more synchronization signal blocks (SSBs) transmitted by the network node 210 as part of the random access procedure. Other advancements for random access procedures include selective or dynamic monitoring of one or more RACH resources by the network node 210 (e.g., for improved network energy savings), repetitions of one or messages during a random access procedure (e.g., to improve coverage or reliability), preamble partitions (e.g., to group random access preambles into partitions dedicated for respective capabilities, functions, or device types), support for NTNs (e.g., random access preambles dedicated for NTN, or timing advance or frequency pre-compensation performed by the UE 220 prior to initiating a random access procedure), support for IoT devices (e.g., preamble sequences optimized for IoT networks, a dedicated control channel for random access procedures, power control mechanisms to adjust transmission power based on an estimated channel quality or network congestion, or AI/ML-based congestion prediction for IoT networks to adjust a configuration for random access procedures by the network node 210), support for multi-user random access (e.g., such as non-orthogonal multiple access (NOMA)), or one or more AI/ML techniques (e.g., preamble selection by the UE 220 using an AI/ML model), among other examples.

As used herein, a downlink signal may be or include a reference signal, control information, or data. For example, downlink reference signals include a primary synchronization signal (PSS), a secondary synchronization signal (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220 or may transmit, to the UE 220, an indication of an MCS to be applied for an uplink signal.

A network node 210 or a UE 220 (such as by using the processing system 245 or the processing system 240, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 210 or the UE 220 (for example, using the processing system 245 or the processing system 240, respectively, or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 or one or more modems) may further perform spatial processing (for example, precoding) on the encoded information to generate one or more processed or precoded signals for downlink or uplink transmission, respectively. In some examples, the network node 210a or the UE 220a may perform codebook-based precoding or non-codebook-based precoding. Codebook-based precoding may involve selecting a precoder (for example, a precoding matrix) using a codebook. For example, the network node 210a may provide precoding information indicating which precoder, defined by the codebook, is to be used by the UE 220a. Non-codebook-based precoding may involve selecting or deriving a precoder based on, or otherwise associated with, one or more downlink or uplink signal measurements. The network node 210a or the UE 220a may transmit the processed downlink or uplink signals, respectively, via one or more antennas.

The network node 210a or the UE 220a may receive uplink signals or downlink signals, respectively, via one or more antennas. The network node 210a or the UE 220a (for example, using the processing system 245 or the processing system 240, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 210 or the UE 220 via the downlink or uplink signals. The network node 210a or the UE 220a (for example, using the processing system 245 or the processing system 240, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 220 and a network node 210 may perform MIMO communication. MIMO communication generally refers to transmitting or receiving multiple signals (such as multiple layers or multiple data streams) simultaneously over the same time and frequency resources. A network node 210 or a UE 220 may communicate using single-user MIMO or multi-user MIMO (MU-MIMO), the latter of which being used by a network node 210 to simultaneously transmit signals to multiple UEs 220. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 210 may generate one or more beams 260a, and a UE 220 may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 210 or a UE 220 may implement massive MIMO, which may be associated with an increased (for example, “massive”) quantity of antennas at the network node 210 or at the UE 220, such as in a network implementing mmWave technology, which enables more precise beamforming or reduced interference. In some examples, the wireless communication network 200 may implement multi-TRP (mTRP) operation (including redundant transmission or reception on multiple TRPs) or non-coherent joint transmission (NC-JT).

The network node 210 and the UE 220 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 210 transmitting signals (for example, SSBs or other signals) via respective beams (for example, of the beams 260 of the network node 210) and the UE 220 receiving and measuring the signal(s) via respective beams of multiple beams (for example, from the beams 260 of the UE 220) to identify a best beam (or beam pair) for communication between the UE 220 and the network node 210. A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 265 (for example, one or more network nodes 210, one or more UEs 220, one or more servers, or one or more components of a cloud computing network, among other examples). For example, in a deployment in which AI/ML functionality is performed independently at a device 265, sometimes referred to as “overlay AI/ML,” the AI/ML model (or an instance or portion of the AI/ML model) may be deployed at a UE 220 (for example, by the processing system 240), a network node 210 (for example, by the processing system 245), one or more servers, or one or more components of a cloud computing network, among other examples. Additionally, or alternatively, in a deployment where AI/ML functionality is coordinated between different devices 265, sometimes referred to as “coordinated AI/ML,” or performed at all device and network layers, sometimes referred to as “native AI/ML,” the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, or efficient use of network bandwidth, or to reduce latency, among other examples). For example, the AI/ML model(s) may be trained to identify patterns or relationships in data corresponding to the wireless communication network 200, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 220, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a network entity (e.g., the UE 220) may include a communication manager 250. As described in more detail elsewhere herein, the communication manager 250 may receive first configuration information indicating a sub-band for SBFD time intervals, wherein the sub-band includes one or more first frequency domain resources; receive second configuration information indicating a BWP, wherein the BWP includes one or more second frequency domain resources, and wherein the one or more second frequency domain resources are included in the one or more first frequency domain resources based on configuration of the first configuration information; receive an indication of a frequency domain resource allocation for a random access message, wherein the frequency domain resource allocation is based on at least one of the sub-band or the BWP; and transmit, using the frequency domain resource allocation, the random access message. As described in more detail elsewhere herein, the communication manager 250 may receive first configuration information indicating a sub-band for SBFD time intervals, wherein the sub-band includes one or more first frequency domain resources; receive second configuration information indicating an active BWP, wherein the active BWP includes one or more second frequency domain resources; receive an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; and transmit, using the frequency domain resource allocation, the random access message Additionally, or alternatively, the communication manager 250 may perform one or more other operations described herein.

In some aspects, a network entity (e.g., a network node 210) may include a communication manager 255. As described in more detail elsewhere herein, the communication manager 255 may transmit first configuration information indicating a sub-band for SBFD time intervals, wherein the sub-band includes one or more first frequency domain resources; transmit second configuration information indicating a BWP, wherein the BWP includes one or more second frequency domain resources, and wherein the one or more second frequency domain resources are included in the one or more first frequency domain resources based on configuration of the first configuration information; transmit an indication of a frequency domain resource allocation for a random access message, wherein the frequency domain resource allocation is based on at least one of the sub-band or the BWP; and receive, using the frequency domain resource allocation, the random access message. As described in more detail elsewhere herein, the communication manager 255 may transmit first configuration information indicating a sub-band for SBFD time intervals, wherein the sub-band includes one or more first frequency domain resources; transmit second configuration information indicating an active BWP, wherein the active BWP includes one or more second frequency domain resources;

transmit an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; and receive, using the frequency domain resource allocation, the random access message. Additionally, or alternatively, the communication manager 255 may perform one or more other operations described herein.

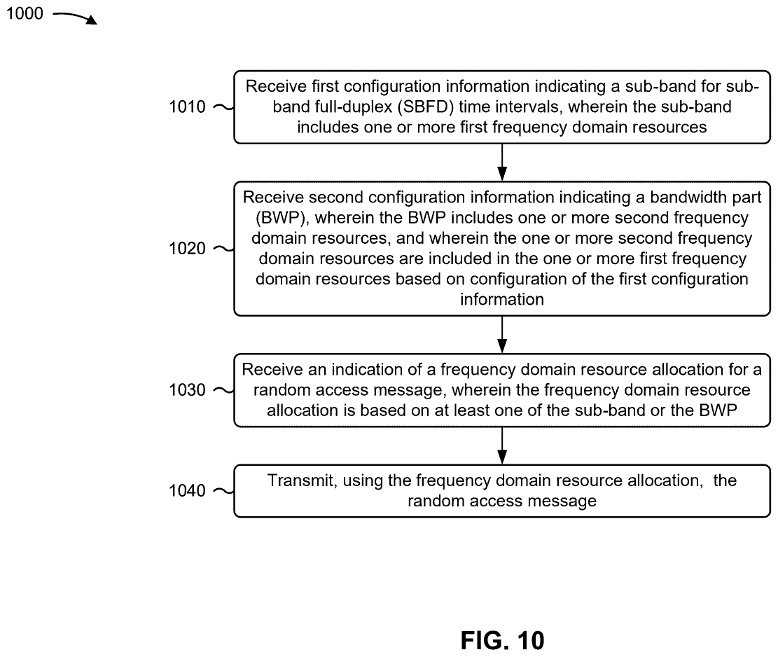

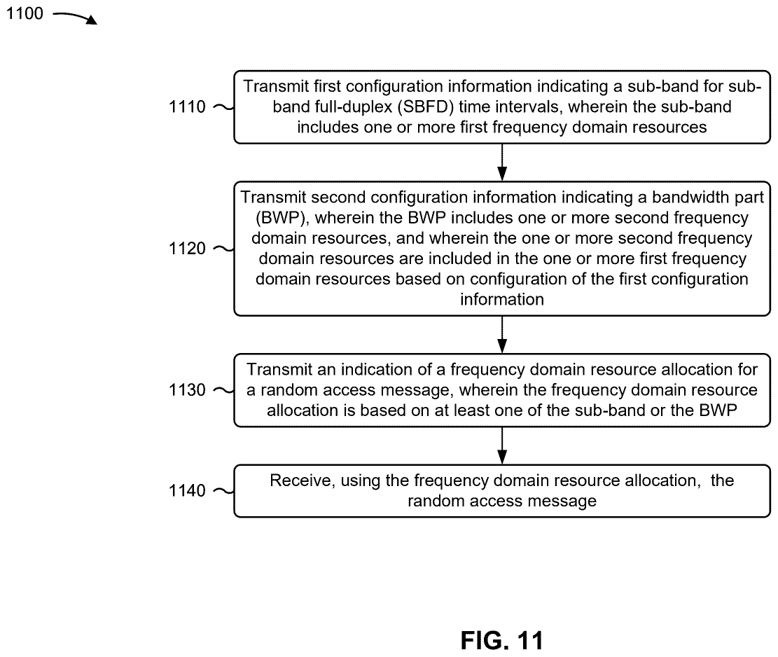

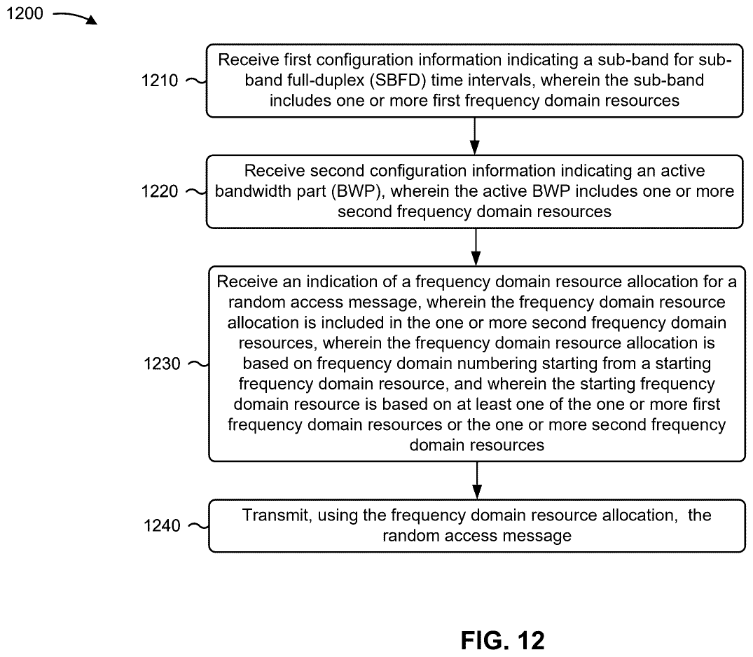

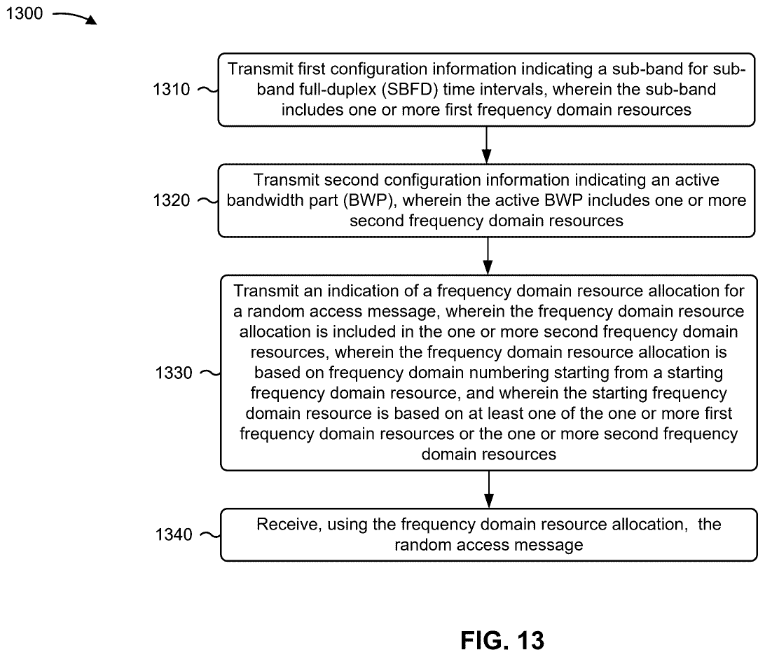

The network entity 102, the processing system 110 of the network entity 102, the network entity 106, the processing system 112 of the network entity 106, the network node 210, the processing system 245 of the network node 210, the UE 220, the processing system 240 of the UE 220, or any other component(s) of FIGS. 1-2 may implement one or more techniques or perform one or more operations associated with an FDRA for a random access message in SBFD scenarios, as described in more detail elsewhere herein. For example, the processing system 110 of the network entity 102, the processing system 112 of the network entity 106, the processing system 245 of the network node 210, or the processing system 240 of the UE 220 may perform or direct operations of, for example, process 1000 of FIG. 10, process 1100 of FIG. 11, process 1200 of FIG. 12, process 1300 of FIG. 13, or other processes as described herein (alone or in conjunction with one or more other processors). Memory of the network node 210 may store data and program code (or instructions) for the network node 210. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, or the UE 220 may cause the one or more processors to perform process 1000 of FIG. 10, process 1100 of FIG. 11, process 1200 of FIG. 12, process 1300 of FIG. 13, or other processes as described herein. In some examples, executing instructions may include running the instructions, converting the instructions, compiling the instructions, or interpreting the instructions, among other examples.

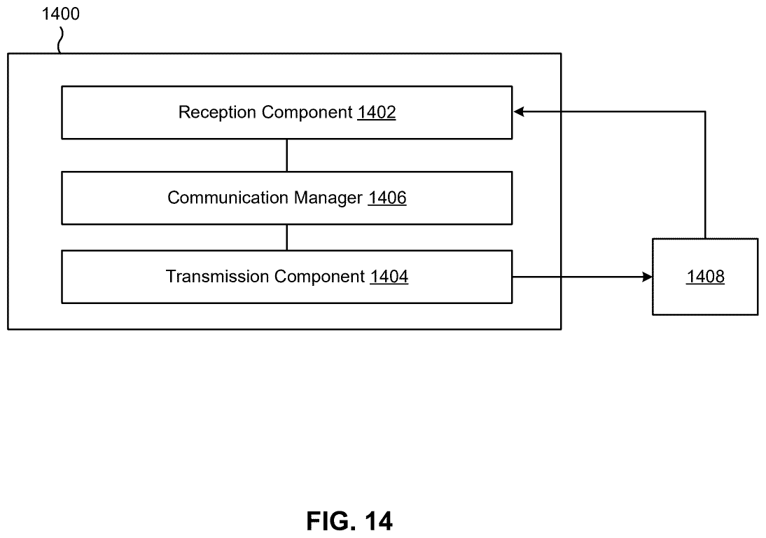

In some aspects, a network entity (e.g., the UE 220) includes means for receiving first configuration information indicating a sub-band for SBFD time intervals, wherein the sub-band includes one or more first frequency domain resources; means for receiving second configuration information indicating a BWP, wherein the BWP includes one or more second frequency domain resources, and wherein the one or more second frequency domain resources are included in the one or more first frequency domain resources based on configuration of the first configuration information; means for receiving an indication of a frequency domain resource allocation for a random access message, wherein the frequency domain resource allocation is based on at least one of the sub-band or the BWP; or means for transmitting, using the frequency domain resource allocation, the random access message. Additionally, or alternatively, the network entity includes means for receiving first configuration information indicating a sub-band for SBFD time intervals, wherein the sub-band includes one or more first frequency domain resources; means for receiving second configuration information indicating an active BWP, wherein the active BWP includes one or more second frequency domain resources; means for receiving an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; or means for transmitting, using the frequency domain resource allocation, the random access message. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1402 depicted and described in connection with FIG. 14) or a transmission component (for example, transmission component 1404 depicted and described in connection with FIG. 14), among other examples.

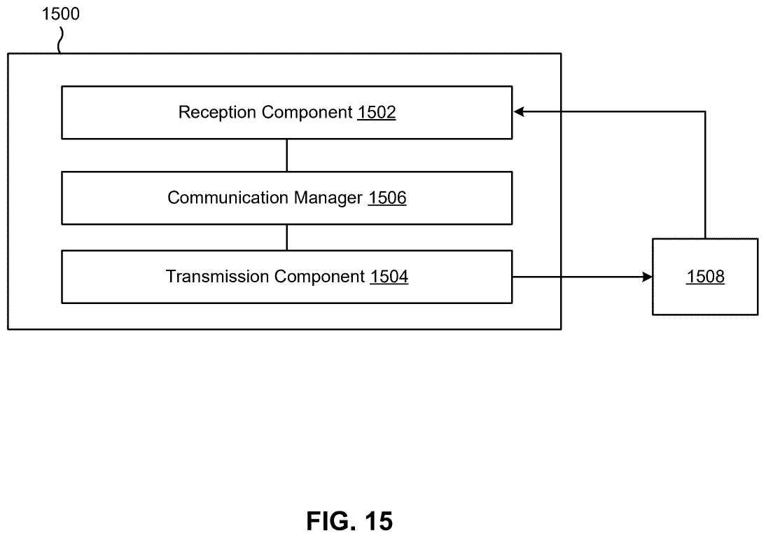

In some aspects, the network entity includes means for transmitting first configuration information indicating a sub-band for SBFD time intervals, wherein the sub-band includes one or more first frequency domain resources; means for transmitting second configuration information indicating a BWP, wherein the BWP includes one or more second frequency domain resources, and wherein the one or more second frequency domain resources are included in the one or more first frequency domain resources based on configuration of the first configuration information; means for transmitting an indication of a frequency domain resource allocation for a random access message, wherein the frequency domain resource allocation is based on at least one of the sub-band or the BWP; or means for receiving, using the frequency domain resource allocation, the random access message. Additionally, or alternatively, the network entity includes means for transmitting first configuration information indicating a sub-band for SBFD time intervals, wherein the sub-band includes one or more first frequency domain resources; means for transmitting second configuration information indicating an active BWP, wherein the active BWP includes one or more second frequency domain resources; means for transmitting an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; or means for receiving, using the frequency domain resource allocation, the random access message In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

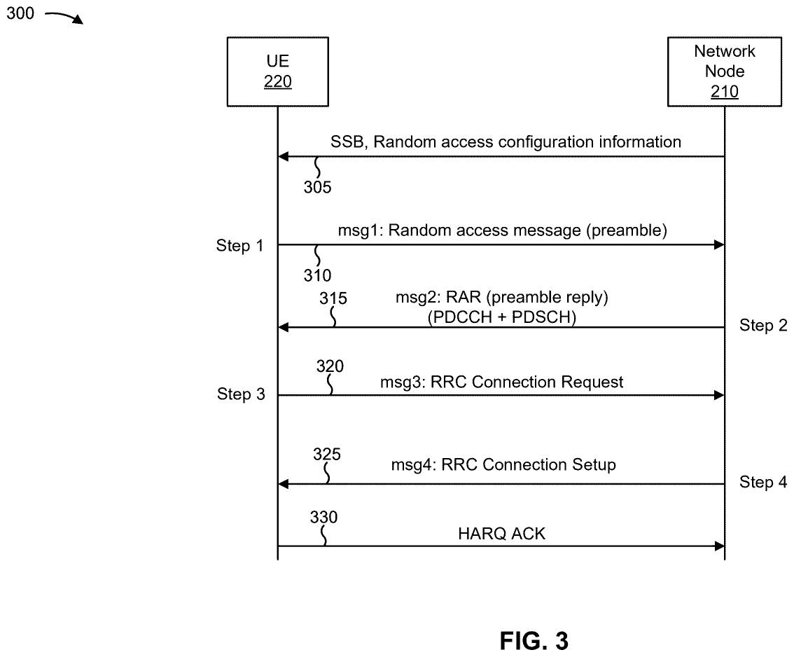

FIG. 3 is a diagram illustrating an example 300 of a four-step random access procedure. As shown in FIG. 3, a network node 210 and a UE 220 may communicate with one another to perform the four-step random access procedure.

As shown by reference number 305, the network node 210 may transmit, and the UE 220 may receive, one or more SSBs and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in a RRC message or a PDCCH order message that triggers a RACH procedure, such as for contention-free random access. The random access configuration information may include one or more parameters to be used in the random access procedure, such as one or more parameters for transmitting a RAM or one or more parameters for receiving an RAR.

As shown by reference number 310, the UE 220 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 315, the network node 210 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 220 in msg1). Additionally, or alternatively, the RAR may indicate a resource allocation to be used by the UE 220 to transmit message 3 (msg3).

In some aspects, as part of the second step of the four-step random access procedure, the network node 210 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 210 may transmit the PDSCH communication for the RAR, as scheduled by the PDCCH communication. The RAR may be included in a MAC protocol data unit (PDU) of the PDSCH communication.

In some examples, the RAR may include, or indicate, an FDRA for a subsequent random access message, such as an RRC connection request message described below (e.g., a msg3). For example, the RAR may include a resource indication value (RIV) that indicates the FDRA. When a msg3 is scheduled by a RAR, the frequency domain numbering (e.g., the RB numbering) for frequency domain resource allocation starts from either a first frequency domain resource (e.g., a first RB) in the initial uplink BWP or the frequency domain resource (e.g., a first RB) of the active uplink BWP. As used herein, a “first” frequency resource (e.g., a “first” RB) refers to a frequency resource (e.g., an RB) that occurs first in an order of frequency resources. In some examples, the first frequency resource may be a frequency resource (e.g., an RB) having a lowest frequency among a set of frequency resources.

The start of the frequency domain number may be the first RB of the initial BWP if the initial BWP is included in the active BWP. For example, if the active uplink BWP and the initial uplink BWP have the same subcarrier spacing and the same cyclic prefix length, and if the active uplink BWP includes all RBs of the initial uplink BWP (or if the active uplink BWP is the initial uplink BWP), then the start of the frequency domain number may be the first RB of the initial BWP. Otherwise, the frequency domain number may start from a first frequency domain resource (e.g., a first RB) of the active uplink BWP. The maximum number of RBs for frequency allocation may be equal to the quantity of RBs in the initial uplink BWP.

In some examples, the UE 220 may determine (e.g., interpret or process) the FDRA based on a size of the initial uplink BWP. For example, the UE 220 may perform a truncation operation for the FDRA if the size of the initial uplink BWP does not satisfy a threshold. The UE 220 may perform an expansion operation if the size of the initial uplink BWP satisfies a threshold. As an example, the threshold may be 180 RBs. For example, a quantity of allocated bits for the FDRA (e.g., in a frequency domain resource assignment field) in the RAR may be fixed to a value, such as 14 bits (e.g., irrespective of a size of the initial uplink BWP). For a truncation operation, the UE 220 may truncate the frequency domain resource assignment field to a subset of bits. The UE 220 may interpret or process the truncated frequency domain resource assignment field to determine the FDRA. For example, the UE 220 may truncate the frequency domain resource assignment field to

$$⌈ {log}_{2} ( {N}_{BWP}^{size} \cdot \frac{( {N}_{BWP}^{size} + 1 )}{2} ) ⌉$$

least significant bits, where

$$⌈ {log}_{2} ( {N}_{BWP}^{size} \cdot \frac{( {N}_{BWP}^{size} + 1 )}{2} ) ⌉ - 14$$

is a quantity of KBS included in the initial uplink BWP. For the expansion operation, the UE 220 may insert one or more bits (e.g., having values of zero (‘0’)) into the frequency domain resource assignment field and then interpret or process the expanded frequency domain resource assignment field to determine the FDRA. For example, the UE 220 may insert

$$⌈ {log}_{2} ( {N}_{RB}^{UL , BWP} \cdot \frac{( {N}_{RB}^{UL , BWP} + 1 )}{2} ) ⌉$$

most significant bits (e.g., with a value set to zero) after one or more frequency hopping bits in the frequency domain resource assignment field.

As shown by reference number 320, the UE 220 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 325, the network node 210 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 330, if the UE 220 successfully receives the RRC connection setup message, the UE 220 may transmit a HARQ ACK.

In some examples, an FDRA for a random access message, such as an RRC connection request message (e.g., a msg3), may be indicated via DCI, such as for a retransmission of the random access message. In such examples, a frequency domain resource assignment field in DCI may include

$$⌈ {log}_{2} ( {N}_{RB}^{UL , BWP} \cdot \frac{( {N}_{RB}^{UL , BWP} + 1 )}{2} ) ⌉ - {N}_{UL , hop}$$

bits that indicate the FDRA, where

$${N}_{BWP}^{size}$$

is the quantity of RBs included in the initial uplink BWP. If frequency hopping is used, then

$${N}_{RB}^{UL , BWP}$$

bits in the frequency domain resource assignment field in DCI may indicate the FDRA, where NUL, hop is the quantity of bits used for frequency hopping.

As indicated above, FIG. 3 is provided as an example. Other examples may differ from what is described with regard to FIG. 3.

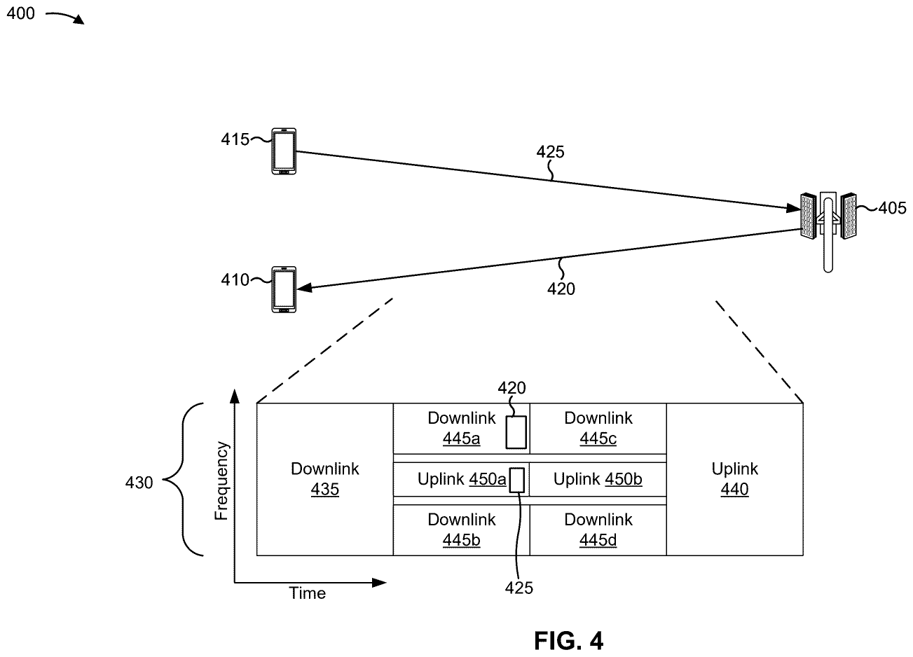

FIG. 4 is a diagram illustrating an example 400 of SBFD operation. As shown in FIG. 4, a first network entity 405 may communicate with a second network entity 410 and a third network entity 415. In some examples, the first network entity 405 may be a network node 210, the second network entity 410 may be a first UE 220, and the third network entity 415 may be a second UE 220. In other examples, the first network entity 405 may be a UE 220. In some examples, the first network entity 405 may communicate with the second network entity 410 and the third network entity 415 using a time division duplex (TDD) configuration (e.g., in a frequency band configured for, or designated for, TDD operation).

In some examples, the first network entity 405 may operate in a full-duplex mode. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol). SBFD communication may also be referred to as “sub-band frequency division duplex (SBFDD)” or “flexible duplex.” In SBFD, the first network entity 405 may transmit a first communication 420 (e.g., a downlink communication) to the second network entity 410 and receive a second communication 425 (e.g., an uplink communication) from the third network entity 415 at the same time, but on different frequency resources. For example, the different frequency resources may be sub-bands of a frequency band 430, such as a TDD band. The frequency band 430 may be a channel bandwidth. The frequency resources used for downlink communication may be separated from the frequency resources used for uplink communication, in the frequency domain, by a guard band. SBFD enables the first network entity 405 to operate in a frequency division duplex (FDD) manner in a TDD frequency band, thereby improving resource utilization or reducing latency, among other examples.

As shown in FIG. 4, the frequency band 430 (e.g., a channel bandwidth) in a TDD band may include one or more time intervals defined, or configured, by a TDD configuration. As shown in FIG. 4, a downlink time interval 435 and an uplink time interval 440 may be configured. The downlink time interval 435 may be a non-SBFD time interval configured for downlink operation. The uplink time interval 440 may be a non-SBFD time interval configured for uplink operation. Additionally, one or more SBFD time intervals may be configured. FIG. 4 shows two SBFD time intervals as an example. An SBFD time interval may include one or more downlink sub-bands 445 and one or more uplink sub-bands 450. For example, FIG. 4 depicts two downlink sub-bands 445 (e.g., a downlink sub-band 445a and a downlink sub-band 445b in a first SBFD time interval and an downlink sub-band 445c and a downlink sub-band 445d in a second SBFD time interval) in each SBFD time interval and one uplink sub-band 450 (e.g., an uplink sub-band 450a in the first SBFD time interval and an uplink sub-band 450b in the second SBFD time interval). As an example, the first communication 420 may be transmitted using time-frequency resources included in the downlink sub-band 445a and the second communication 425 may be transmitted using time-frequency resources included in the uplink sub-band 450a. Therefore, the first network entity 405 may transmit the first communication 420 and receive the second communication 425 at least partially at the same time, thereby improving resource utilization or reducing latency, among other examples.

As indicated above, FIG. 4 is provided as an example. Other examples may differ from what is described with respect to FIG. 4.

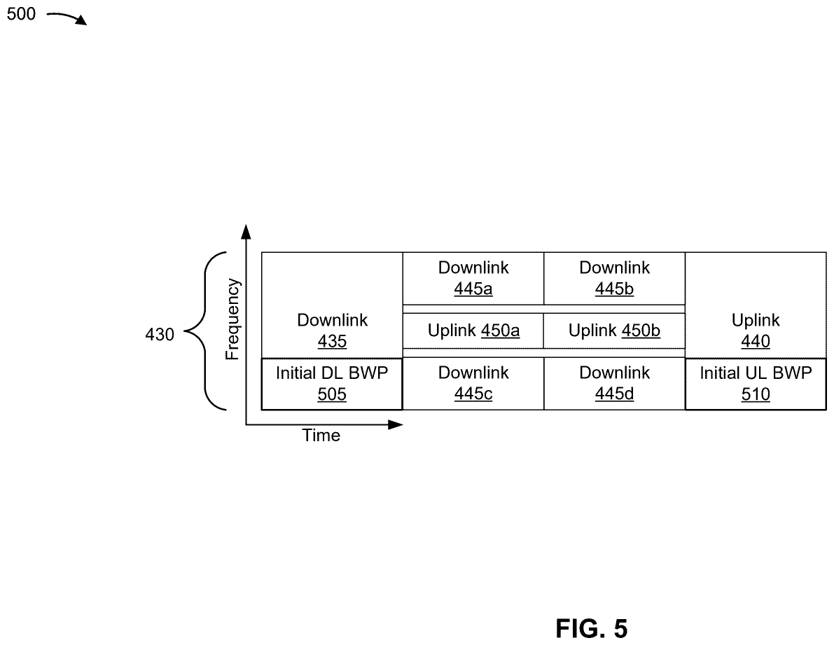

FIG. 5 is a diagram illustrating an example 500 of initial BWPs in SBFD scenarios. The frequency band 430 depicted and described in connection with FIG. 4 is shown in FIG. 5. As shown in FIG. 5, an initial downlink (DL) BWP 505 and an initial uplink BWP may be configured.

As described elsewhere herein, an FDRA (e.g., for a random access message, such as a message described in connection with FIG. 3) may be indicated based on, or in accordance with, a BWP configuration. For example, the FDRA may be within a range of frequency domain resources (e.g., a range of RBs). For example, the range of the frequency domain resources may include all frequency domain resources of the initial uplink BWP 510 (e.g., if the active uplink BWP and the initial uplink BWP 510 have the same subcarrier spacing and cyclic prefix length and the active uplink BWP includes all RBs of the initial uplink BWP 510, or if the active uplink BWP is the initial uplink BWP 510). In such examples, frequency domain numbering (e.g., for indicating the frequency domain resource allocation) may start at a first RB of the initial uplink BWP 510 and end at a last RB of the initial uplink BWP 510. In other examples, the frequency domain numbering may start at a first RB of the active uplink BWP and a maximum quantity of RBs included in the frequency domain resource allocation may be the quantity of RBs in the initial uplink BWP 510.

However, current mechanisms for FDRAs for random access messages (such as msg3) do not account for SBFD configurations. This may result in conflicts or inefficient resource utilization for SBFD time intervals. For example, uplink scheduling during SBFD time intervals may be restricted to one or more usable frequency domain resources. In this context, “usable” frequency domain resource may refer to a resource that is included in both an active uplink BWP and an uplink sub-band (e.g., as indicated by the SBFD configuration). For example, for uplink, useable RBs may be determined as RBs included in an intersection between a cell-specific uplink sub-band (e.g., the uplink sub-band 450) and the initial uplink BWP 510. As frequency domain numbering for FDRAs for random access messages (such as msg3) may start at a first RB of the initial uplink BWP 510 or an active BWP, this may result in SBFD time intervals being unusable for scheduling the random access messages (such as msg3). For example, as shown in FIG. 5, the initial uplink BWP 510 may not overlap in the frequency domain with the uplink sub-band 450 configured by the SBFD configuration. For example, center frequencies of the initial uplink BWP 510 and the initial downlink BWP 505 may be aligned (e.g., may be the same frequency). Therefore, a larger initial uplink BWP 510 and initial downlink BWP 505 may need to be used so that a frequency range of the initial uplink BWP 510 includes at least a portion of the uplink sub-band 450. This may consume network resources associated with using larger initial BWPs. Alternatively, there may be an increased likelihood of the initial uplink BWP 510 or the active BWP not overlapping in the frequency domain with the uplink sub-band 450 configured by the SBFD configuration, resulting in the SBFD time intervals being unusable for random access messages (such as msg) during SBFD time intervals. This may increase latency associated with the random access messages or result in inefficient resource utilization, among other examples.

As indicated above, FIG. 5 is provided as an example. Other examples may differ from what is described with respect to FIG. 5.

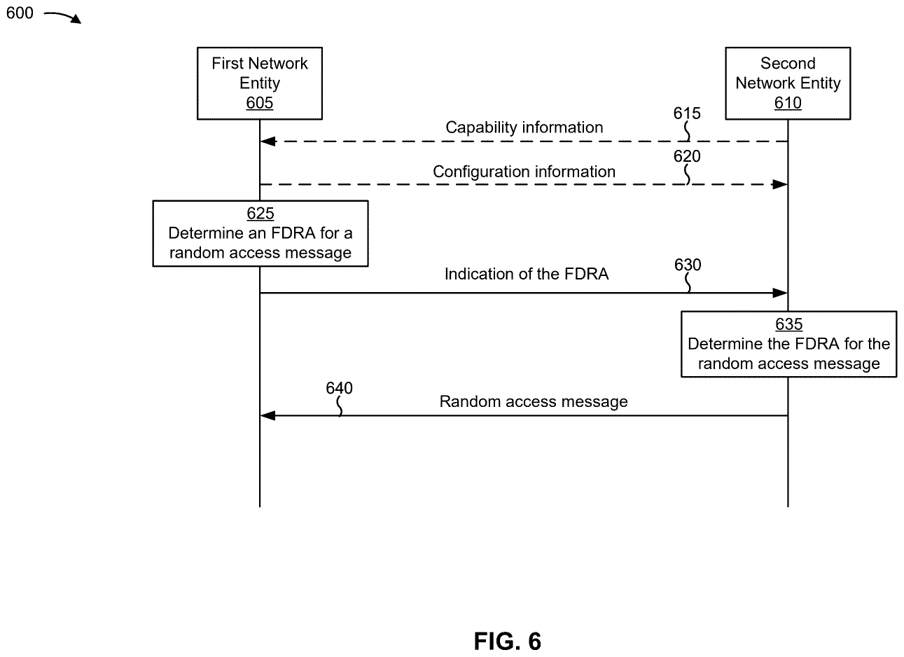

FIG. 6 is a diagram of an example 600 associated with a frequency domain resource allocation for a random access message in SBFD scenarios. As shown in FIG. 6, a first network entity 605 (e.g., a network node 210, a UE 220, the network entity 102, or the network entity 106) may communicate with a second network entity 610 (e.g., a network node 210, a UE 220, the network entity 102, or the network entity 106). In some aspects, the first network entity 605 and the second network entity 610 may be part of a wireless network (e.g., the wireless communication network 200). The first network entity 605 and the second network entity 610 may operate using a TDD band (e.g., a TDD frequency band).

In some aspects, as shown by reference number 615, the second network entity 610 may transmit capability information. The capability information may be included in a capability report. The second network entity 610 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the second network entity 610. The one or more parameters may be indicated via respective information elements (IEs) included in a capability report.

The capability information may indicate whether the second network entity 610 supports a feature or one or more parameters related to the feature. For example, the capability information may indicate a capability or parameter for supporting an SBFD configuration (e.g., in a TDD band). As another example, the capability information may indicate a capability or parameter for supporting a random access procedure during SBFD time intervals. One or more operations described herein may be based on capability information. For example, the second network entity 610 may perform a communication in accordance with the capability information, or may receive configuration information that is in accordance with the capability information. In some aspects, the capability information may indicate support for receiving, obtaining, determining, or processing an FDRA for a random access message based on a sub-band (e.g., frequency resources of an uplink sub-band) or a BWP (e.g., frequency resources of an initial uplink BWP or an active uplink BWP) when an SBFD configuration is provided or is active, as described in more detail elsewhere herein.

As shown by reference number 620, the first network entity 605 may transmit, and the second network entity 610 may receive, configuration information. In some aspects, the second network entity 610 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the second network entity 610 or previously indicated by the network node or other network device), or explicit configuration information for the second network entity 610 to use to configure the second network entity 610, among other examples.

In some examples, the configuration information may not be expressly signaled to the second network entity 610. For example, in some aspects, the configuration information may at least partially be defined by a wireless communication standard, such as the 3GPP. In such examples, the first network entity 605 may not explicitly indicate such configuration information to the second network entity 610. For example, the second network entity 610 may optionally obtain at least a portion of the configuration information from a configuration stored by the second network entity 610 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may include an SBFD configuration (e.g., that configures one or more SBFD time intervals in a similar manner as depicted and described in connection with FIG. 4). For example, the SBFD configuration may configure one or more SBFD time intervals and one or more non-SBFD time intervals (e.g., one or more of downlink time intervals, uplink intervals, or flexible time intervals described elsewhere herein).

In some examples, the configuration information may indicate one of a first configuration type or a second configuration type associated with SBFD operation. For example, the first configuration type may enable uplink transmissions during one of the one or more SBFD time intervals or the one or more non-SBFD time intervals. Additionally, the second configuration type may enable uplink transmissions during both of the one or more SBFD time intervals and the one or more non-SBFD time intervals.

In some examples, the configuration information may indicate one or more frequency resource sets associated with the uplink transmission (e.g., one or more PUCCH resource sets). For example, the configuration may indicate a single frequency resource set for uplink transmissions during both the SBFD time intervals and the non-SBFD time intervals. Alternatively, the configuration information may indicate a first frequency resource set for uplink transmissions during the SBFD time intervals and a second frequency resource set for uplink transmissions during the non-SBFD time intervals. For example, the first network entity 605 may transmit, and the second network entity 610 may receive, an indication of a sub-band (e.g., an uplink sub-band) for SBFD time intervals. The sub-band may include one or more first frequency domain resources (e.g., one or more RBs).

In some examples, the configuration information may include a BWP configuration. For example, the configuration information may include a serving cell configuration (e.g., a ServingCellConfig RRC IE). The serving cell configuration may indicate a TDD configuration (e.g., the SBFD configuration), an initial downlink BWP (e.g., an initialDownlinkBWP IE), a default downlink BWP, or an uplink configuration (e.g., an uplinkConfig IE). The uplink configuration may indicate an initial downlink BWP (e.g., an initialUplinkBWP IE), a first active uplink BWP, or one or more other uplink BWPs, among other examples. For example, for a given BWP, the configuration information may indicate a frequency domain location (e.g., a center frequency) and a bandwidth (e.g., a quantity of frequency domain resources, such as RBs, included in the BWP) for the BWP, such as via an RIV in the configuration information. For example, a BWP configured via the configuration information may include one or more second frequency domain resources (e.g., one or more second RBs)

In some aspects, the one or more second frequency domain resources may be included in the one or more first frequency domain resources (e.g., of the sub-band, such as an uplink sub-band, configured via the SBFD configuration) based on configuration of the first configuration information. In other words, if SBFD operation is configured, then the BWP may be included in the configured sub-band for SBFD operation. For example, the BWP may be within the frequency resource(s) of the sub-band because the sub-band is configured (e.g., because SBFD is configured, the BWP may be restricted to be within the sub-band). For example, the first network entity 605 may determine the one or more second frequency domain resources in accordance with one or more restrictions based on SBFD operation being configured or active. For example, SBFD operation being configured or active may be a condition for the one or more restrictions being applicable. The one or more restrictions may include the BWP being within a sub-band of an SBFD time interval. For example, the one or more restrictions may include an initial uplink BWP being within an uplink sub-band for SBFD. For example, to enable initial access or random access during SBFD time intervals before RRC connection is established, the first network entity 605 may configure the initial uplink BWP to be included within an uplink sub-band in the SBFD time intervals.

In some examples, the BWP (e.g., the initial uplink BWP) and the sub-band (e.g., the uplink sub-band) may have the same size in the frequency domain. For example, the one or more first frequency domain resources (e.g., of the sub-band) may be the same as the one or more second frequency domain resources (e.g., of the BWP). In some other examples, a quantity of RBs in the initial uplink BWP may be less than the quantity of RBs in the uplink sub-band (e.g., the initial uplink BWP may be subset of the uplink sub-band). For example, the one or more second frequency domain resources (e.g., of the BWP) may be a subset of the one or more first frequency domain resources (e.g., of the sub-band). In some aspects, if the configuration information (e.g., a SIB) does not include a configuration of the BWP (e.g., an initial uplink BWP), then the second network entity 610 may determine that the BWP (e.g., the initial uplink BWP) is the same as the sub-band. In other words, if the initial uplink BWP is not configured by a SIB, then the second network entity 610 may assume the uplink sub-band is the initial uplink BWP. This may ensure that SBFD time intervals can be used for random access as the first network entity 605 may be enabled to schedule a random access message (e.g., the msg3) to occur during an SBFD time interval (e.g., in the uplink sub-band).

In some aspects, a first frequency domain resource included in the one or more first frequency domain resources (e.g., a first RB of the sub-band) may be the same as (e.g., may be aligned in the frequency domain with) a first frequency domain resource included in the one or more second frequency domain resources (e.g., a first RB of the BWP). For example, the one or more restrictions may include the first frequency domain resources of the sub-band (e.g., the uplink sub-band) and the BWP (e.g., the initial uplink BWP) being aligned. This may reduce uplink resource fragmentation. Reducing uplink resource fragmentation can reduce the complexity of resource allocation algorithms and improve the overall performance of the network. For example, when the first RB of the sub-band is aligned with the first RB of the BWP, the first network entity 605 can more easily allocate contiguous RBs for uplink transmissions, reducing the need for complex fragmentation handling.

The second network entity 610 may configure itself based at least in part on the configuration information. In some aspects, the second network entity 610 may be configured to perform one or more operations described herein based at least in part on the configuration information.

As shown by reference number 625, the first network entity 605 may determine an FDRA for a random access message. For example, the random access message may be an msg3, such as the RRC connection request depicted and described in connection with FIG. 3 and reference number 320. For example, the second network entity 610 may transmit, and the first network entity 605 may receive, a RAM (e.g., a msg1) as part of a random access procedure. The first network entity 605 may determine an FDRA to be used by the second network entity 610 for transmitting the msg3 (e.g., the random access message) based on, in response to, or otherwise associated with receiving the RAM. In other examples, the FDRA may be for a retransmission of the random access message.

In some examples, the FDRA may be based on the sub-band. The FDRA may be based on the sub-band in that a frequency domain numbering (e.g., an RB numbering) used to indicate the FDRA may be based on the frequency domain resources included in the sub-band (e.g., the uplink sub-band). For example, the frequency domain numbering may include a range of frequency domain resources that includes the one or more first frequency domain resources (e.g., included in the sub-band). In some aspects, a first frequency domain resource in the frequency domain numbering (e.g., a first RB or a starting RB in the frequency domain numbering) may be a first frequency domain resource in the one or more first frequency domain resources (e.g., a first RB of the sub-band). The use of sub-band-based FDRA (e.g., the uplink sub-band-based) enables a more flexible frequency resource assignment (e.g., because the whole range of usable frequency domain resources can be covered when the second network entity 610 is operating in a connected mode, such as an RRC connected mode). In some examples, the first network entity 605 may determine the FDRA such that the FDRA is included within the BWP (e.g., the initial uplink BWP or an active uplink BWP).

In some other examples, the FDRA may be based on the BWP (e.g., the initial uplink BWP or an active uplink BWP). The FDRA may be based on the sub-band in that a frequency domain numbering (e.g., an RB numbering) used to indicate the FDRA may be based on the frequency domain resources included in the BWP (e.g., the initial uplink BWP or the active uplink BWP). For example, the frequency domain numbering may include a range of frequency domain resources that includes the one or more second frequency domain resources (e.g., included in the BWP). In some aspects, a first frequency domain resource in the frequency domain numbering (e.g., a first RB or a starting RB in the frequency domain numbering) may be a first frequency domain resource in the one or more second frequency domain resources (e.g., a first RB of the BWP). The use of a BWP-based FDRA (e.g., an initial uplink BWP based FDRA and an active uplink BWP based FDRA) may improve alignment or consistency with frequency domain allocations for non-SBFD operation. This reduces the complexity associated with the allocating or processing frequency domain resource allocations because the first network entity 605 and the second network entity 610 may use similar processes or algorithms for SBFD scenarios as non-SBFD scenarios.

In some examples, the BWP may be an active BWP (e.g., an active uplink BWP). In such examples, during non-SBFD time intervals, a starting frequency domain resource in the frequency domain numbering (e.g., a first RB or a starting RB in the frequency domain numbering) may be a first frequency domain resource in the active BWP (e.g., a first RB of the active BWP). In other examples, during non-SBFD time intervals, the starting frequency domain resource in the frequency domain numbering (e.g., a first RB or a starting RB in the frequency domain numbering) may be offset from the first frequency domain resource in the active BWP by a frequency offset (e.g., the starting frequency domain resource may be based on an offset from a first frequency domain resource included in the one or more frequency domain resources of the active BWP). In some examples, the configuration information may indicate the frequency offset. The frequency offset may include one or more RBs. In some examples, during non-SBFD time intervals, the starting frequency domain resource in the frequency domain numbering (e.g., a first RB or a starting RB in the frequency domain numbering) may be a first usable frequency domain resource in the sub-band (e.g., where the first usable frequency domain resource is based on a frequency location of the active BWP). In some other examples, during non-SBFD time intervals, the starting frequency domain resource in the frequency domain numbering (e.g., a first RB or a starting RB in the frequency domain numbering) may be a first frequency resource (e.g., a first RB) in an initial BWP (e.g., an initial uplink BWP) if the initial BWP is included within the active BWP. In some examples, during SBFD time intervals, the starting frequency domain resource in the frequency domain numbering (e.g., a first RB or a starting RB in the frequency domain numbering) may be a first usable frequency domain resource in the sub-band (e.g., where the first usable frequency domain resource is based on a frequency location of the active BWP). As described elsewhere herein, the first usable frequency resource may be a first frequency resource included in both the frequency domain resources of the sub-band and frequency domain resources of the active BWP.

In some examples, where the BWP is the active BWP, the quantity of frequency domain resources (e.g., the quantity of RBs) included in the range for the frequency domain numbering may be based on the size of the sub-band (e.g., the quantity of RBs included in the uplink sub-band). As another example, where the BWP is the active BWP, the quantity of frequency domain resources (e.g., the quantity of RBs) included in the range for the frequency domain numbering may be based on the size of the initial BWP (e.g., the quantity of RBs included in the initial uplink BWP).

As shown by reference number 630, the first network entity 605 may transmit, and the second network entity 610 may receive, an indication of the FDRA for the random access message. In some examples, the indication of the FDRA (e.g., an RIV indicating the FDRA) may be included in another random access message, such as a msg2 or an RAR message. In some other examples, the indication of the FDRA (e.g., an RIV indicating the FDRA) may be included in DCI, such as for scheduling a retransmission of the random access message.

As described above, the FDRA may be based on the sub-band (e.g., the SBFD sub-band) or the BWP. For example, a frequency domain numbering (e.g., RB numbering) used to indicate the FDRA (e.g., used for the RIV) may be based on frequency domain resources of the sub-band or frequency domain resources of the BWP (e.g., an initial uplink BWP or an active uplink BWP). As an example, a starting frequency domain resource for the frequency domain numbering may be a first frequency domain resource in the BWP or a first frequency domain resource in the sub-band (e.g., in the uplink sub-band).

In some examples, for sub-band-based FDRAs, one or more first values for the RIV are based on the one or more first frequency domain resources (e.g., of the sub-band). For example, the first network entity 605 may be able to indicate the one or more first frequency domain resources via the RIV (e.g., in accordance with the frequency domain numbering described herein). The one or more first values may be available values (or numbered values in the frequency domain numbering) in that the first network entity 605 is capable of indicating the one or more first values via the RIV using the sub-band-based frequency domain numbering (e.g., RV numbering). In some examples, one or more second values for the RIV are based on the one or more second frequency domain resources of the BWP (e.g., of the initial uplink BWP). The one or more second values may be a subset of the one or more first values. In some examples, the one or more second values may be admissible values for the RIV in that the one or more second values are values that the first network entity 605 can indicate to ensure that the FDRA for the random access message is within the frequency domain resources of the BWP (e.g., of the initial uplink BWP). The admissible values may also be referred to as permitted values, or valid values, among other examples.

For example, the one or more second values may indicate the one or more second frequency domain resources of the BWP (e.g., of the initial uplink BWP). For example, because the second network entity 610 may be operating in an RRC idle mode or an RRC inactive mode, the second network entity 610 may only be configured with the BWP (e.g., the initial uplink BWP). Therefore, the first network entity 605 may be restricted to indicating the one or more second values via the RIV to ensure that the FDRA for the random access message is within the frequency domain resources of the BWP (e.g., of the initial uplink BWP). This improves the likelihood of the second network entity 610 being able to transmit the random access message because the FDRA is within the BWP that the second network entity 610 has been configured with in the RRC idle mode or the RRC inactive mode.

In other examples, for BWP-based FDRAs, one or more values for the RIV may be based on the one or more second frequency domain resources of the BWP (e.g., of the initial uplink BWP). For example, where BWP-based frequency domain numbering is applied, the available values for the RIV may be the one or more second values. In such examples, all of the one or more second values may be admissible values or permitted values because the available values for the RIV correspond to the one or more second frequency domain resources of the BWP (e.g., of the initial uplink BWP). This may reduce complexity for selecting or indicating the RIV as the first network entity 605 may not have to determine restrictions for the admissible values of the RIV.

In some wireless communication network, the channel bandwidth is expected to increase, such as up to 400 MHz or larger. In some examples, a nominal subcarrier spacing may be 60 kHz, such as for an FR3 band. Assuming such a configuration, the total quantity of RBs that can be transmitted via the channel bandwidth may increase to 528. When using SBFD symbols, the total quantity of RBs will be reduced (such as to 523) to account for a guard band, which enables interference mitigation between adjacent frequency sub-bands.

To fully utilize this increased quantity of RBs, the granularity of the RIV may be higher. For example, the FDRA may include 18 bits to enable the first network entity 605 to indicate FDRAs that cover a full range of the channel bandwidth, such as 528 RBs. In some examples, a range of frequency domain resources that can be indicated by an FDRA may be based on (e.g., defined by) a size of the FDRA (e.g., a quantity of bits included in the FDRA) and a granularity used by the RIV. The granularity may refer to a size or type of frequency resource indicated by a value indicated by the RIV, such as an RB or an RB group (RBG). An RBG may include two or more RBs. In some examples, the RIV may have a size of 14 bits and use an RB-based granularity (e.g., in which the range of RBs that the RIV can indicate is 180 RBs).

In other examples, the RIV may use an RBG granularity. This enables the first network entity 605 to indicate a larger range of frequency domain resources without increasing an overhead for signaling (e.g., without increasing the size of the RIV). As an example, using an FDRA that includes 14 bits and an RBG granularity with an RBG size of two RBs, the range of RBs that the RIV can indicate is 360 RBs. In other examples, a size of the RIV may be greater than 14 bits. In such examples, the RIV may use an RB granularity. This may enable the first network entity 605 to indicate a larger range of frequency domain resources with a smaller granularity (e.g., an RB granularity), thereby improving the flexibility of frequency domain resource allocations. In some examples, the FDRA may have a size of 18 bits or another quantity of bits. In some examples, the FDRA (e.g., with an FDRA indication size greater than 14 bits) may use an RBG granularity (e.g., to increase the range of frequency domain resources that can be indicated by the first network entity 605 using the RIV).

As shown by reference number 635, the second network entity 610 may determine the FDRA for the random access message (e.g., based on the indication of the FDRA, such as the RIV). The second network entity 610 may determine the FDRA from information (e.g., one or more bits) included in the indication of the FDRA. The indication of the FDRA may include an RIV (e.g., the FDRA may indicate the RIV). In some examples, the FDRA may be included in a random access message, such as an RAR (e.g., an msg2). In some other examples, the FDRA may be included in control information, such as DCI.

In some examples, a size of the indication of the frequency domain resource allocation may be based on a quantity of one or more RBGs included in the one or more first frequency domain resources (e.g., in the sub-band for SBFD, such as an uplink sub-band). For example, the second network entity 610 may determine (e.g., interpret or process) the FDRA based on a size of the sub-band. For example, the second network entity 610 may perform a truncation operation for the FDRA if the quantity of one or more RBGs included sub-band does not satisfy a threshold. The second network entity 610 may perform an expansion operation if the quantity of one or more RBGs included sub-band satisfies the threshold. For example, a quantity of allocated bits for the FDRA (e.g., in a frequency domain resource assignment field) in a RAR may be fixed to a value, such as 14 bits, 18 bits, or another value (e.g., irrespective of a size of the initial uplink BWP or the sub-band). For a truncation operation, the second network entity 610 may truncate the frequency domain resource assignment field to a subset of bits. The second network entity 610 may interpret or process the truncated frequency domain resource assignment field to determine the RIV. For example, the second network entity 610 may truncate the frequency domain resource assignment field to

$$⌈ {log}_{2} ( {N}_{RBG}^{UL , SB} \cdot \frac{( {N}_{RBG}^{UL , SB} + 1 )}{2} ) ⌉$$

least significant bits, where

$${N}_{RBG}^{UL , SB}$$

is the quantity of one or more RBGs included sub-band (e.g., the uplink sub-band). In some examples, a size of the RIV (e.g., an FDRA bitfield size in a RAR) may be

$$⌈ {log}_{2} ( {N}_{RBG}^{UL , SB} \cdot \frac{( {N}_{RBG}^{UL , SB} + 1 )}{2} ) ⌉ - {N}_{UL , hop} ,$$

where N_{UL,hop} is a quantity of bits used for frequency hopping (e.g., frequency hopping bits).

For the expansion operation, the second network entity 610 may insert one or more bits (e.g., having values of zero (‘0’)) into the frequency domain resource assignment field and then interpret or process the expanded frequency domain resource assignment field to determine the FDRA. For example, the second network entity 610 may insert

$$⌈ {log}_{2} ( {N}_{RBG}^{UL , SB} \cdot \frac{( {N}_{RBG}^{UL , SB} + 1 )}{2} ) ⌉ - 14$$

most significant bits (e.g., with a value set to zero) after one or more frequency hopping bits in the frequency domain resource assignment field.

In some examples, the second network entity 610 may interpret, process, obtain, or otherwise determine the RIV from

$$⌈ {log}_{2} ( {N}_{RBG}^{UL , SB} \cdot \frac{( {N}_{RBG}^{UL , SB} + 1 )}{2} ) ⌉ - {N}_{UL , hop}$$

least significant bits in the frequency domain resource assignment field in the RAR (e.g., if the quantity of one or more RBGs included sub-band does not satisfy the threshold or if greater than 14 bits are used for the RIV). In other examples, the second network entity 610 may interpret, process, obtain, or otherwise determine the RIV from 14—N_{UL,hop} least significant bits in the frequency domain resource assignment field in the RAR (e.g., if the quantity of one or more RBGs included sub-band does not satisfies the threshold). In examples, where the N_{UL,hop} bits are outside of the indication of the FDRA, the second network entity 610 may interpret, process, obtain, or otherwise determine the FDRA from

$$⌈ {log}_{2} ( {N}_{RBG}^{UL , SB} \cdot \frac{( {N}_{RBG}^{UL , SB} + 1 )}{2} ) ⌉$$

least significant bits in the frequency domain resource assignment field in the RAR (e.g., if the quantity of one or more RBGs included sub-band does not satisfy the threshold or if greater than 14 bits are used for the FDRA).

In some other examples, a size of the indication of the frequency domain resource allocation is based on a quantity of one or more RBGs included in the one or more second frequency domain resources (e.g., of the BWP, such as the initial uplink BWP). For example, the second network entity 610 may determine (e.g., interpret or process) the FDRA based on a size of the BWP (e.g., the initial uplink BWP). For example, the second network entity 610 may perform a truncation operation for the FDRA if the quantity of one or more RBGs included BWP does not satisfy a threshold. The second network entity 610 may perform an expansion operation if the quantity of one or more RBGs included BWP satisfies the threshold. For a truncation operation, the second network entity 610 may truncate the frequency domain resource assignment field to a subset of bits. The second network entity 610 may interpret or process the truncated frequency domain resource assignment field to determine the FDRA. For example, the second network entity 610 may truncate the frequency domain resource assignment field to

$$⌈ {log}_{2} ( {N}_{RBG}^{UL , BWP} \cdot \frac{( {N}_{RBG}^{UL , BWP} + 1 )}{2} ) ⌉$$

least significant bits, where

$${N}_{RBG}^{UL , BWP}$$

is the quantity of one or more RBGs included BWP (e.g., the initial uplink BWP). In some examples, a size of the RIV (e.g., an FDRA bitfield size in a RAR) may be

$$⌈ {log}_{2} ( {N}_{RBG}^{UL , BWP} . \frac{( {N}_{RBG}^{UL , BWP} + 1 )}{2} ) ⌉ - {N}_{UL , hop} ,$$

where N_{UL,hop} is a quantity of bits used for frequency hopping (e.g., frequency hopping bits).

For the expansion operation, the second network entity 610 may insert one or more bits (e.g., having values of zero (‘0’)) into the frequency domain resource assignment field and then interpret or process the expanded frequency domain resource assignment field to determine the RIV. For example, the second network entity 610 may insert

$$⌈ {log}_{2} ( {N}_{RBG}^{UL , BWP} . \frac{( {N}_{RBG}^{UL , BWP} + 1 )}{2} ) ⌉ - 14$$

most significant bits (e.g., with a value set to zero) after one or more frequency hopping bits in the frequency domain resource assignment field.

In some examples, the second network entity 610 may interpret, process, obtain, or otherwise determine the RIV from

$$⌈ {log}_{2} ( {N}_{RBG}^{UL , BWP} . \frac{( {N}_{RBG}^{UL , BWP} + 1 )}{2} ) ⌉ - {N}_{UL , hop}$$

least significant bits in the frequency domain resource assignment field in the RAR (e.g., if the quantity of one or more RBGs included BWP does not satisfy the threshold or if greater than 14 bits are used for the FDRA). In other examples, the second network entity 610 may interpret, process, obtain, or otherwise determine the RIV from 14—N_{UL,hop} least significant bits in the frequency domain resource assignment field in the RAR (e.g., if the quantity of one or more RBGs included BWP does not satisfies the threshold). In examples, where the N_{UL,hop} bits are outside of the indication of the RIV, the second network entity 610 may interpret, process, obtain, or otherwise determine the RIV from

$$⌈ {log}_{2} ( {N}_{RBG}^{UL , BWP} . \frac{( {N}_{RBG}^{UL , BWP} + 1 )}{2} ) ⌉$$

least significant bits in the frequency domain resource assignment field in the RAR (e.g., if the quantity of one or more RBGs included BWP does not satisfy the threshold or if greater than 14 bits are used for the RIV).

As described elsewhere herein, the indication of the frequency domain resource allocation may be included in control information, such as DCI. In such examples, a size of the indication in the control information (e.g., a quantity of bits that indicate FDRA) may be based on a size of the one or more second frequency domain resources (e.g., included in the BWP, such as the initial uplink BWP). In such examples, the quantity of bits used to indicate the RIV may be

$$⌈ {log}_{2} ( {N}_{RBG}^{UL , BWP} . \frac{( {N}_{RBG}^{UL , BWP} + 1 )}{2} ) ⌉ .$$

In some examples, the quantity of bits may be

$$⌈ {log}_{2} ( {N}_{RBG}^{UL , BWP} . \frac{( {N}_{RBG}^{UL , BWP} + 1 )}{2} ) ⌉ + {N}_{UL , hop}$$

is the RIV is derived from

$$⌈ {log}_{2} ( {N}_{RBG}^{UL , BWP} . \frac{( {N}_{RBG}^{UL , BWP} + 1 )}{2} ) ⌉$$

bits (e.g., enabling the first network entity 605 to indicate all available values for the RIV). In some examples, the DCI (e.g., used for scheduling a retransmission of the random access message) may have a size that is based on the BWP when the RAR (e.g., that scheduled the initial transmission of the random access message) uses BWP-based FDRA, as described elsewhere herein. This may reduce complexity by ensuring the RAR and the DCI indicate the FDRA for instances (e.g., an initial transmission and one or more retransmissions) of the random access message in a similar manner.

In other examples, where the initiation of the FDRA is included in control information (e.g., DCI), a size of the indication in the control information is based on a size of the one or more first frequency domain resources (e.g., included in the sub-band, such as an SBFD uplink sub-band). In such examples, the quantity of bits used to indicate the RIV may be

$$⌈ {log}_{2} ( {N}_{RBG}^{UL , SB} \cdot \frac{( {N}_{RBG}^{UL , SB} + 1 )}{2} ) ⌉ .$$

In some examples, the quantity of bits may be

$$⌈ {log}_{2} ( {N}_{RBG}^{UL , SB} \cdot \frac{( {N}_{RBG}^{UL , SB} + 1 )}{2} ) ⌉ + {N}_{UL , hop}$$

if the RIV is derived from

$$⌈ {log}_{2} ( {N}_{RBG}^{UL , SB} \cdot \frac{( {N}_{RBG}^{UL , SB} + 1 )}{2} ) ⌉$$

bits (e.g., enabling the first network entity 605 to indicate all available values for the RIV). In some examples, the DCI (e.g., used for scheduling a retransmission of the random access message) may have a size that is based on the sub-band when the RAR (e.g., that scheduled the initial transmission of the random access message) uses sub-band-based FDRA, as described elsewhere herein. This may reduce complexity by ensuring the RAR and the DCI indicate the FDRA for instances (e.g., an initial transmission and one or more retransmissions) of the random access message in a similar manner.

In some examples, the FDRA may be associated with one or more frequency hopping bits. For example, the indication of the FDRA may include the one or more frequency hopping bits (e.g., N_{UL,hop}). A quantity of the one or more frequency hopping bits may be based on a size of the BWP or a size of the sub-band, depending on whether the FDRA is BWP-based or sub-band-based. For example, if the FDRA is BWP-based, then the quantity of the one or more frequency hopping bits may be based on a size of the BWP (e.g., the initial uplink BWP). As another example, if the FDRA is sub-band-based, then the quantity of the one or more frequency hopping bits is based on the size of the sub-band. For example, the quantity of the one or more frequency hopping bits may be different for different sizes of the sub-band.

In some examples, the frequency hopping bit(s) may indicate a frequency hopping offset. In some examples, the frequency hopping offset may be based on the time interval type (e.g., SBFD or non-SBFD) in which the random access message is scheduled to occur. For example, if the time interval type is the SBFD type, then the frequency hopping offset may be based on a quantity of one or more usable frequency domain resources included in the one or more second frequency domain resources (e.g., included in the initial uplink BWP or active uplink BWP). As another example, the time interval type may be the non-SBFD type, and the frequency hopping offset may be based on a size of the BWP (e.g., an initial uplink BWP or an active uplink BWP) or a size of the sub-band. In other examples, the frequency hopping offset may be fixed in all time interval types and may be indicated by the size of the sub-band or the size of the BWP.

In some examples, the random access message may be scheduled in an active BWP (e.g., via DCI). In such examples, the second network entity 610 may determine (e.g., interpret or process) the frequency domain resource allocation based on a size of the initial BWP (e.g., the initial uplink BWP). For example, the FDRA may indicate a first FDRA. The second network entity 610 may determine a second FDRA based on the first FDRA and the size of the initial BWP. In other words, the indicated FDRA (e.g., the first FDRA) may be re-interpreted as, using, based on, or otherwise associated with the size of the initial BWP (e.g., the initial uplink BWP).

In some other examples, the second network entity 610 may determine (e.g., interpret or process) the frequency domain resource allocation based on a size of the sub-band (e.g., the uplink sub-band). For example, the FDRA may indicate a first FDRA. The second network entity 610 may determine a second FDRA based on the first FDRA and the size of the sub-band. In other words, the indicated FDRA (e.g., the first FDRA) may be re-interpreted as, using, based on, or otherwise associated with the size of the sub-band (e.g., the uplink sub-band).

In other examples, the second network entity 610 may determine the FDRA based on a size of an RBG used for the active BWP. For example, the FDRA may indicate a first FDRA. The second network entity 610 may determine a second FDRA based on the first FDRA and the size of the RBG used for the active BWP. In other words, the indicated FDRA (e.g., the first FDRA) may be re-interpreted as, using, based on, or otherwise associated with the size of the RBG used for the active BWP. In some examples, the size of the RBG may be different for different time interval types (e.g., a first RBG size for SBFD time intervals and a second RBG size for non-SBFD time intervals). In some examples, the second FDRA may start from a first RB in the active BWP, a first usable RB in the active BWP, or an offset from a first RB in the initial BWP.

As an example, a size of the FDRA may be based on a size of the initial BWP. In such examples, the size of the RBG may be two for SBFD time intervals and four for non-SBFD time intervals. Therefore, the second network entity 610 may determine the second FDRA to be double the originally indicated FDRA in SBFD time intervals. For example, if L is the length of allocated RBs (e.g., a quantity of allocated RBs) indicated by a RIV derived from the FDRA and RBstart is the starting resource block derived from the RIV, then the quantity of RBs for the FDRA may be (2×L) blocks and the starting RB may be at (2×RBstart). The second network entity 610 may determine the second FDRA to be quadruple the originally indicated FDRA in non-SBFD time intervals. For example, if L is the length of allocated RBs (e.g., a quantity of allocated RBs) indicated by a RIV derived from the FDRA and RBstart is the starting resource block derived from the RIV, then the quantity of RBs for the FDRA may be (4×L) blocks and the starting RB may be at (4×RBstart).

As shown by reference number 640, the second network entity 610 may transmit, and the first network entity 605 may receive, the random access message. The second network entity 610 may transmit the random access message using frequency domain resources indicated by the FDRA (e.g., as determined, interpreted, or processed by the second network entity 610 as described in connection with reference number 635). In some examples, the second network entity 610 may transmit, and the first network entity 605 may receive, the random access message during an SBFD time interval (e.g., where the frequency domain resources indicated by the FDRA are within the sub-band (an uplink sub-band)). In other examples, the second network entity 610 may transmit, and the first network entity 605 may receive, the random access message during a non-SBFD time interval, such as an uplink time interval.

As indicated above, FIG. 6 is provided as an example. Other examples may differ from what is described with respect to FIG. 6.

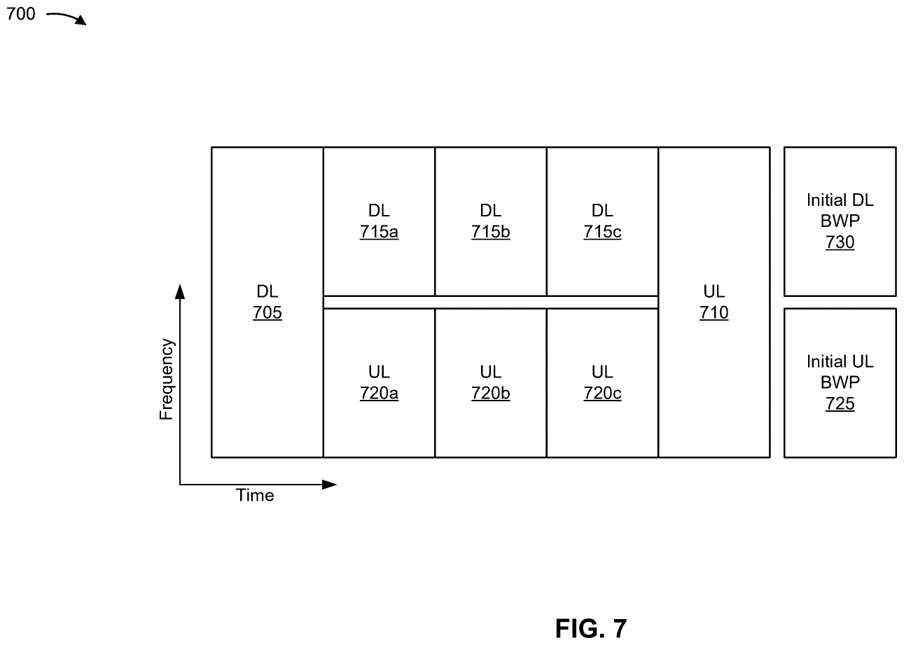

FIG. 7 is a diagram of an example 700 associated with a restriction of an initial BWP in SBFD scenarios.

As shown in FIG. 7, a network entity (e.g., the second network entity 610) may be configured to operate in a TDD band that includes one or more non-SBFD time intervals (such as a downlink time interval 705 and an uplink time interval 710) and one or more SBFD time intervals. As shown in FIG. 7, an SBFD time interval may include a downlink sub-band 715 (shown as downlink sub-band 715a in a first SBFD time interval, downlink sub-band 715b in a second SBFD time interval, and downlink sub-band 715c in a third SBFD time interval). The SBFD time interval may include an uplink sub-band 720 (shown as uplink sub-band 720a in the first SBFD time interval, uplink sub-band 720b in the second SBFD time interval, and uplink sub-band 720c in the third SBFD time interval). The downlink sub-band 715 and the uplink sub-band 720 may be separated by a guard band.

As shown in FIG. 7, the network entity may be configured to operate using one or more initial BWPs, such as an initial uplink BWP 725 and an initial downlink BWP 730. A frequency domain location of the initial BWPs may be restricted based on, or in response to, SBFD operation being configured or activated. For example, if SBFD operation is configured, then the initial BWP may be included in a corresponding sub-band for SBFD operation. “Corresponding” sub-band may refer to a sub-band associated with the same communication direction (e.g., uplink or downlink) as the initial BWP. For example, as shown in FIG. 7, the initial uplink BWP 725 may be configured within the frequency domain resources of the uplink sub-band 720. Similarly, the initial downlink BWP 730 may be configured within the frequency domain resources of the downlink sub-band 715.

For example, the initial BWP may be within the frequency resource(s) of the corresponding sub-band because the sub-band is configured (e.g., because SBFD is configured, the initial BWP may be restricted to be within the sub-band). For example, SBFD operation being configured or active may be a condition for the one or more restrictions being applicable. The one or more restrictions may include the initial BWP being within a corresponding sub-band of an SBFD time interval. For example, the one or more restrictions may include an initial uplink BWP 725 being within an uplink sub-band 720 for SBFD. For example, to enable initial access or random access during SBFD time intervals before RRC connection is established, the first network entity 605 may configure the initial uplink BWP 725 to be included within an uplink sub-band 720 in the SBFD time intervals.

In some examples, the initial BWP (e.g., the initial uplink BWP 725) and the sub-band (e.g., the uplink sub-band 720) may have the same size in the frequency domain (e.g., as shown in FIG. 7). For example, one or more first frequency domain resources (e.g., of the uplink sub-band 720) may be the same as the one or more second frequency domain resources (e.g., of the initial uplink BWP 725). In some other examples, a quantity of RBs in the initial uplink BWP 725 may be less than the quantity of RBs in the uplink sub-band 720 (e.g., the initial uplink BWP 725 may be subset of the uplink sub-band 720). For example, the one or more second frequency domain resources (e.g., of the initial uplink BWP 725) may be a subset of the one or more first frequency domain resources (e.g., of the uplink sub-band 720). In some aspects, if the configuration information (e.g., a SIB) does not include a configuration of the initial uplink BWP 725, then the network entity may determine that the initial uplink BWP 725 is the same as the uplink sub-band 720. In other words, if the initial uplink BWP 725 is not configured by a SIB, then the network entity may assume the uplink sub-band 720 is the initial uplink BWP 725.

As indicated above, FIG. 7 is provided as an example. Other examples may differ from what is described with respect to FIG. 7.

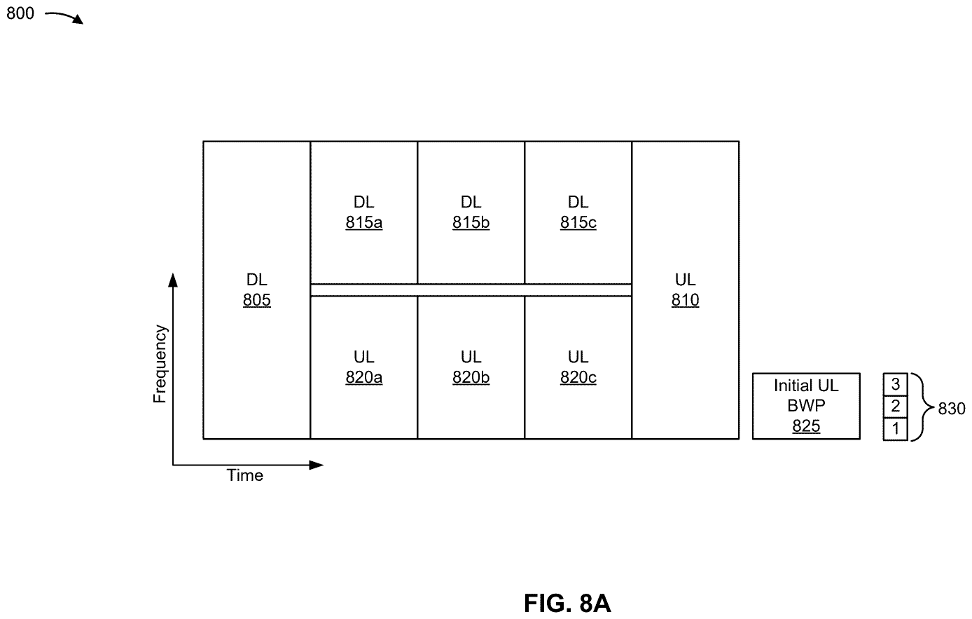

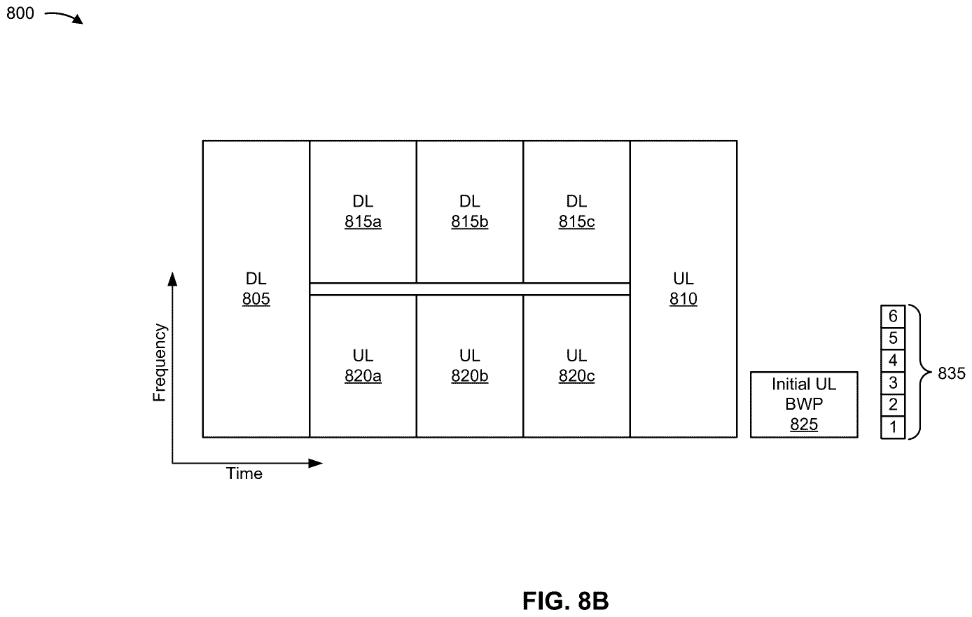

FIGS. 8A and 8B are diagrams of an example 800 associated with frequency domain numbering for FDRAs in SBFD scenarios. FIG. 8A depicts an example of BWP-based frequency domain numbering and FIG. 8B depicts an example of sub-band-based frequency domain numbering.

As shown in FIGS. 8A and 8B, a network entity (e.g., the second network entity 610) may be configured to operate in a TDD band that includes one or more non-SBFD time intervals (such as a downlink time interval 805 and an uplink time interval 810) and one or more SBFD time intervals. As shown in FIG. 8, an SBFD time interval may include a downlink sub-band 815 (shown as downlink sub-band 815a in a first SBFD time interval, downlink sub-band 815b in a second SBFD time interval, and downlink sub-band 815c in a third SBFD time interval). The SBFD time interval may include an uplink sub-band 820 (shown as uplink sub-band 820a in the first SBFD time interval, uplink sub-band 820b in the second SBFD time interval, and uplink sub-band 820c in the third SBFD time interval). The downlink sub-band 815 and the uplink sub-band 820 may be separated by a guard band. As shown in FIGS. 8A and 8B, the network entity may be configured to operate using one or more initial BWPs, such as an initial uplink BWP 825, in a similar manner as described elsewhere herein. In some examples, the quantity of RBs included in the initial uplink BWP 825 is less than the quantity of RBs included in the uplink sub-band 820.

In some examples, an FDRA for a random access message (such as a msg3) may be based on frequency domain resources or a configuration of the initial uplink BWP 825. For example, as shown in FIG. 8A, a frequency domain numbering 830 may be based on the initial uplink BWP 825 (shown as three RBs as an example). As an example, the frequency domain numbering 830 may include RBs numbered starting from a first RB included in the initial uplink BWP 825 and stopping at a last RB in the initial uplink BWP 825. For example, a range of the frequency domain numbering 830 may be based on a range of RBs included in the initial uplink BWP 825.

In some other examples, as shown in FIG. 8B, a frequency domain numbering 835 may be based on the uplink sub-band 820. As an example, the frequency domain numbering 835 may include RBs numbered starting from a first RB included in the uplink sub-band 820 and stopping at a last RB in the uplink sub-band 820 (e.g., shown as six RBs as an example). For example, a range of the frequency domain numbering 835 may be based on a range of RBs included in the uplink sub-band 820.

As indicated above, FIGS. 8A and 8B are provided as examples. Other examples may differ from what is described with respect to FIGS. 8A and 8B.

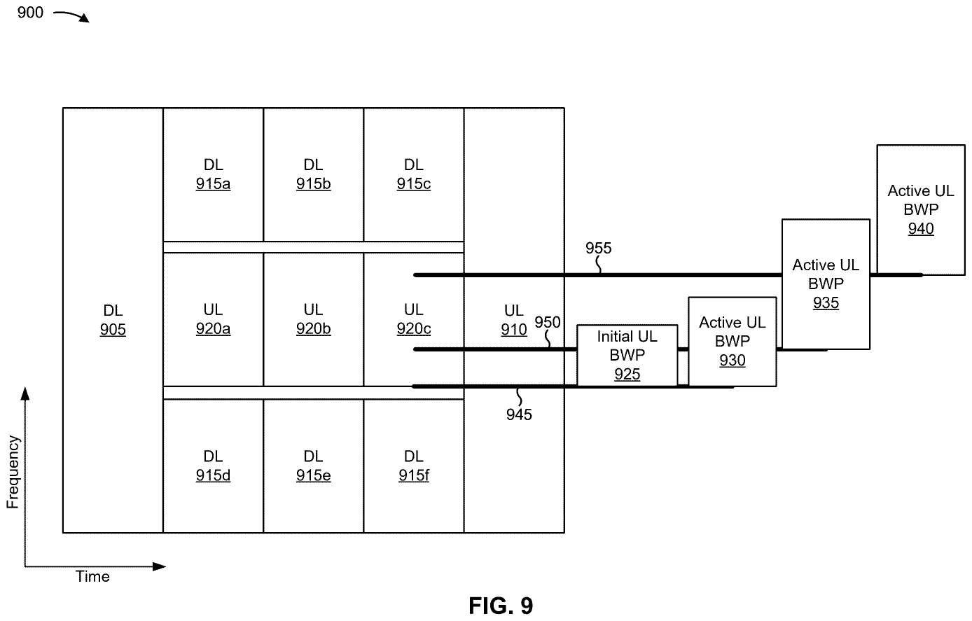

FIG. 9 is a diagram of an example 900 associated with FDRAs in association with an active BWP in SBFD scenarios.

As shown in FIG. 9, a network entity (e.g., the second network entity 610) may be configured to operate in a TDD band that includes one or more non-SBFD time intervals (such as a downlink time interval 905 and an uplink time interval 910) and one or more SBFD time intervals. As shown in FIG. 9, an SBFD time interval may include a downlink sub-band 915 (shown as downlink sub-band 915a in a first SBFD time interval, downlink sub-band 915b in a second SBFD time interval, and downlink sub-band 915c in a third SBFD time interval). The SBFD time interval may include an uplink sub-band 920 (shown as uplink sub-band 920a in the first SBFD time interval, uplink sub-band 920b in the second SBFD time interval, and uplink sub-band 920c in the third SBFD time interval). The downlink sub-band 915 and the uplink sub-band 920 may be separated by a guard band. As shown in FIG. 9, the network entity may be configured to operate using one or more initial BWPs, such as an initial uplink BWP 925, in a similar manner as described elsewhere herein. As shown in FIG. 9, one or more active BWPs may be configured, such as an active uplink BWP 930, an active uplink BWP 935, and an active uplink BWP 940.

FIG. 9 depicts different starting frequency domain locations (e.g., for FDRA frequency domain numbering) within an SBFD time interval for the different active BWPs. In some examples, the starting frequency domain locations may be a first RB in the active BWP. In other examples, the starting frequency domain locations may be a first usable RB in the uplink sub-band 920. For example, the active uplink BWP 930 may have a starting frequency domain location 945 (e.g., that is the first RB in the active uplink BWP 930). As another example, the active uplink BWP 935 may have a starting frequency domain location 950 (e.g., that is the first RB in the active uplink BWP 935). The active uplink BWP 940 may have a starting frequency domain location 955 (e.g., that is the first RB in the active uplink BWP 940).

As indicated above, FIG. 9 is provided as an example. Other examples may differ from what is described with respect to FIG. 9.

FIG. 10 is a diagram illustrating an example process 1000 performed, for example, at a network entity or an apparatus of a network entity. Example process 1000 is an example where the apparatus or the network entity (e.g., the network entity 102, the network entity 106, a UE 220, or the second network entity 610) performs operations associated with an FDRA for a random access message in SBFD scenarios.

As shown in FIG. 10, in some aspects, process 1000 may include receiving first configuration information indicating a sub-band for SBFD time intervals, wherein the sub-band includes one or more first frequency domain resources (block 1010). For example, the network entity (e.g., using reception component 1402 or communication manager 1406, depicted in FIG. 14) may receive first configuration information indicating a sub-band for SBFD time intervals, wherein the sub-band includes one or more first frequency domain resources, as described above.

As further shown in FIG. 10, in some aspects, process 1000 may include receiving second configuration information indicating a BWP, wherein the BWP includes one or more second frequency domain resources, and wherein the one or more second frequency domain resources are included in the one or more first frequency domain resources based on configuration of the first configuration information (block 1020). For example, the network entity (e.g., using reception component 1402 or communication manager 1406, depicted in FIG. 14) may receive second configuration information indicating a BWP, wherein the BWP includes one or more second frequency domain resources, and wherein the one or more second frequency domain resources are included in the one or more first frequency domain resources based on configuration of the first configuration information, as described above.

As further shown in FIG. 10, in some aspects, process 1000 may include receiving an indication of a frequency domain resource allocation for a random access message, wherein the frequency domain resource allocation is based on at least one of the sub-band or the BWP (block 1030). For example, the network entity (e.g., using reception component 1402 or communication manager 1406, depicted in FIG. 14) may receive an indication of a frequency domain resource allocation for a random access message, wherein the frequency domain resource allocation is based on at least one of the sub-band or the BWP, as described above.

As further shown in FIG. 10, in some aspects, process 1000 may include transmitting, using the frequency domain resource allocation, the random access message (block 1040). For example, the network entity (e.g., using transmission component 1404 or communication manager 1406, depicted in FIG. 14) may transmit, using the frequency domain resource allocation, the random access message, as described above.

Process 1000 may include additional aspects, such as any single aspect or any combination of aspects described below or in connection with one or more other processes described elsewhere herein.

In a first aspect, the one or more first frequency domain resources is the same as the one or more second frequency domain resources.

In a second aspect, alone or in combination with the first aspect, the one or more second frequency domain resources are a subset of the one or more first frequency domain resources.

In a third aspect, alone or in combination with one or more of the first and second aspects, the frequency domain resource allocation is based on the sub-band, wherein the frequency domain resource allocation is associated with a frequency domain numbering, and wherein the frequency domain numbering is based on the one or more first frequency domain resources.

In a fourth aspect, alone or in combination with one or more of the first through third aspects, a range of the frequency domain numbering is based on a quantity of the one or more first frequency domain resources.

In a fifth aspect, alone or in combination with one or more of the first through fourth aspects, the frequency domain resource allocation is based on the BWP, wherein the frequency domain resource allocation is associated with a frequency domain numbering, and wherein the frequency domain numbering is based on the one or more second frequency domain resources.

In a sixth aspect, alone or in combination with one or more of the first through fifth aspects, a range of the frequency domain numbering is based on a quantity of the one or more second frequency domain resources.

In a seventh aspect, alone or in combination with one or more of the first through sixth aspects, the frequency domain resource allocation is based on the sub-band, wherein the frequency domain resource allocation is indicated by a RIV, and wherein one or more first values for the RIV are based on the one or more first frequency domain resources.

In an eighth aspect, alone or in combination with one or more of the first through seventh aspects, one or more second values for the RIV are based on the one or more second frequency domain resources.

In a ninth aspect, alone or in combination with one or more of the first through eighth aspects, the one or more second values are a subset of the one or more first values.

In a tenth aspect, alone or in combination with one or more of the first through ninth aspects, the frequency domain resource allocation is based on the BWP, wherein the frequency domain resource allocation is indicated by a resource indication value, and wherein one or more values for the resource indication value are based on the one or more second frequency domain resources.

In an eleventh aspect, alone or in combination with one or more of the first through tenth aspects, the frequency domain resource allocation is indicated by a resource indication value, and wherein the resource indication value uses an RBG granularity.

In a twelfth aspect, alone or in combination with one or more of the first through eleventh aspects, a size of the indication of the frequency domain resource allocation is based on a quantity of one or more RBGs included in the one or more first frequency domain resources.

In a thirteenth aspect, alone or in combination with one or more of the first through twelfth aspects, a size of the indication of the frequency domain resource allocation is based on a quantity of one or more RBGs included in the one or more second frequency domain resources.

In a fourteenth aspect, alone or in combination with one or more of the first through thirteenth aspects, the frequency domain resource allocation is indicated by a resource indication value, and wherein a size of the resource indication value is greater than 14 bits.

In a fifteenth aspect, alone or in combination with one or more of the first through fourteenth aspects, the frequency domain resource allocation is indicated by a resource indication value, and wherein the resource indication value is based on a quantity of one or more hopping bits, a quantity of one or more resource block groups included in the BWP, and a size of indication of the frequency domain resource allocation.

In a sixteenth aspect, alone or in combination with one or more of the first through fifteenth aspects, the frequency domain resource allocation is indicated by a resource indication value, and wherein the resource indication value is based on a quantity of one or more hopping bits, a quantity of one or more resource block groups included in the sub-band, and a size of indication of the frequency domain resource allocation.

In a seventeenth aspect, alone or in combination with one or more of the first through sixteenth aspects, the indication of the frequency domain resource allocation is included in control information, and wherein a size of the indication in the control information is based on a size of the one or more second frequency domain resources.

In an eighteenth aspect, alone or in combination with one or more of the first through seventeenth aspects, the indication of the frequency domain resource allocation is included in control information, and wherein a size of the indication in the control information is based on a size of the one or more first frequency domain resources.

In a nineteenth aspect, alone or in combination with one or more of the first through eighteenth aspects, the frequency domain resource allocation is based on the BWP, wherein the frequency domain resource allocation is associated with one or more frequency hopping bits, and wherein a quantity of the one or more frequency hopping bits is based on a size of the BWP.

In a twentieth aspect, alone or in combination with one or more of the first through nineteenth aspects, the frequency domain resource allocation is based on the sub-band, wherein the frequency domain resource allocation is associated with one or more frequency hopping bits, and wherein a quantity of the one or more frequency hopping bits is based on a size of the sub-band.

In a twenty-first aspect, alone or in combination with one or more of the first through twentieth aspects, transmitting the random access message includes transmitting the random access message during a time interval of a time interval type, wherein the time interval type is an SBFD type or a non-SBFD type, wherein the frequency domain resource allocation is associated with a frequency hopping offset, and wherein the frequency hopping offset is based on the time interval type.

In a twenty-second aspect, alone or in combination with one or more of the first through twenty-first aspects, the time interval type is the SBFD type, and wherein the frequency hopping offset is based on a quantity of one or more usable frequency domain resources included in the one or more second frequency domain resources.

In a twenty-third aspect, alone or in combination with one or more of the first through twenty-second aspects, the time interval type is the non-SBFD type, and wherein the frequency hopping offset is based on a first size of the BWP or a second size of the sub-band.

In a twenty-fourth aspect, alone or in combination with one or more of the first through twenty-third aspects, the frequency domain resource allocation is associated with a frequency hopping offset, and wherein the frequency hopping offset is based on a first size of the BWP or a second size of the sub-band.

In a twenty-fifth aspect, alone or in combination with one or more of the first through twenty-fourth aspects, transmitting the random access message includes transmitting the random access message during an SBFD time interval of the SBFD time intervals.

In a twenty-sixth aspect, alone or in combination with one or more of the first through twenty-fifth aspects, transmitting the random access message includes transmitting the random access message during a non-SBFD time interval.

In a twenty-seventh aspect, alone or in combination with one or more of the first through twenty-sixth aspects, the BWP is an initial BWP.

In a twenty-eighth aspect, alone or in combination with one or more of the first through twenty-seventh aspects, the BWP is an active BWP.

In a twenty-ninth aspect, alone or in combination with one or more of the first through twenty-eighth aspects, the BWP is an uplink BWP, and wherein the sub-band is an uplink sub-band.

In a thirtieth aspect, alone or in combination with one or more of the first through twenty-ninth aspects, the random access message is a first random access message, and wherein the indication of the frequency domain resource allocation is included in a second random access message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network entity or an apparatus of a network entity. Example process 1100 is an example where the apparatus or the network entity (e.g., the network entity 102, the network entity 106, the network node 210, or the first network entity 605) performs operations associated with an FDRA for a random access message in SBFD scenarios.

As shown in FIG. 11, in some aspects, process 1100 may include transmitting first configuration information indicating a sub-band for SBFD time intervals, wherein the sub-band includes one or more first frequency domain resources (block 1110). For example, the network entity (e.g., using transmission component 1504 or communication manager 1506, depicted in FIG. 15) may transmit first configuration information indicating a sub-band for SBFD time intervals, wherein the sub-band includes one or more first frequency domain resources, as described above.

As further shown in FIG. 11, in some aspects, process 1100 may include transmitting second configuration information indicating a BWP, wherein the BWP includes one or more second frequency domain resources, and wherein the one or more second frequency domain resources are included in the one or more first frequency domain resources based on configuration of the first configuration information (block 1120). For example, the network entity (e.g., using transmission component 1504 or communication manager 1506, depicted in FIG. 15) may transmit second configuration information indicating a BWP, wherein the BWP includes one or more second frequency domain resources, and wherein the one or more second frequency domain resources are included in the one or more first frequency domain resources based on configuration of the first configuration information, as described above.

As further shown in FIG. 11, in some aspects, process 1100 may include transmitting an indication of a frequency domain resource allocation for a random access message, wherein the frequency domain resource allocation is based on at least one of the sub-band or the BWP (block 1130). For example, the network entity (e.g., using transmission component 1504 or communication manager 1506, depicted in FIG. 15) may transmit an indication of a frequency domain resource allocation for a random access message, wherein the frequency domain resource allocation is based on at least one of the sub-band or the BWP, as described above.

As further shown in FIG. 11, in some aspects, process 1100 may include receiving, using the frequency domain resource allocation, the random access message (block 1140). For example, the network entity (e.g., using reception component 1502 or communication manager 1506, depicted in FIG. 15) may receive, using the frequency domain resource allocation, the random access message, as described above.

Process 1100 may include additional aspects, such as any single aspect or any combination of aspects described below or in connection with one or more other processes described elsewhere herein.

In a first aspect, the one or more first frequency domain resources and the one or more second frequency domain resources are the same.

In a second aspect, alone or in combination with the first aspect, the one or more second frequency domain resources are a subset of the one or more first frequency domain resources.

In a third aspect, alone or in combination with one or more of the first and second aspects, the frequency domain resource allocation is based on the sub-band, wherein the frequency domain resource allocation is associated with a frequency domain numbering, and wherein the frequency domain numbering is based on the one or more first frequency domain resources.

In a fourth aspect, alone or in combination with one or more of the first through third aspects, a range of the frequency domain numbering is based on a quantity of the one or more first frequency domain resources.

In a fifth aspect, alone or in combination with one or more of the first through fourth aspects, the frequency domain resource allocation is based on the BWP, wherein the frequency domain resource allocation is associated with a frequency domain numbering, and wherein the frequency domain numbering is based on the one or more second frequency domain resources.

In a sixth aspect, alone or in combination with one or more of the first through fifth aspects, a range of the frequency domain numbering is based on a quantity of the one or more second frequency domain resources.

In a seventh aspect, alone or in combination with one or more of the first through sixth aspects, the frequency domain resource allocation is based on the sub-band, wherein the frequency domain resource allocation is indicated by a resource indication value (RIV), and wherein one or more first values for the RIV are based on the one or more first frequency domain resources.

In an eighth aspect, alone or in combination with one or more of the first through seventh aspects, one or more second values for the RIV are based on the one or more second frequency domain resources.

In a ninth aspect, alone or in combination with one or more of the first through eighth aspects, the one or more second values are a subset of the one or more first values.

In a tenth aspect, alone or in combination with one or more of the first through ninth aspects, the frequency domain resource allocation is based on the BWP, wherein the frequency domain resource allocation is indicated by a resource indication value, and wherein one or more values for the resource indication value are based on the one or more second frequency domain resources.

In an eleventh aspect, alone or in combination with one or more of the first through tenth aspects, the frequency domain resource allocation is indicated by a resource indication value, and wherein the resource indication value using a resource block group (RBG) granularity.

In a twelfth aspect, alone or in combination with one or more of the first through eleventh aspects, a size of the indication of the frequency domain resource allocation is based on a quantity of one or more RBGs included in the one or more first frequency domain resources.

In a thirteenth aspect, alone or in combination with one or more of the first through twelfth aspects, a size of the indication of the frequency domain resource allocation is based on a quantity of one or more RBGs included in the one or more second frequency domain resources.

In a fourteenth aspect, alone or in combination with one or more of the first through thirteenth aspects, the frequency domain resource allocation is indicated by a resource indication value, and wherein a size of the resource indication value is greater than 14 bits.

In a fifteenth aspect, alone or in combination with one or more of the first through fourteenth aspects, the frequency domain resource allocation is indicated by a resource indication value, and wherein the resource indication value is based on a quantity of one or more hopping bits, a quantity of one or more resource block groups included in the BWP, and a size of indication of the frequency domain resource allocation.

In a sixteenth aspect, alone or in combination with one or more of the first through fifteenth aspects, the frequency domain resource allocation is indicated by a resource indication value, and wherein the resource indication value is based on a quantity of one or more hopping bits, a quantity of one or more resource block groups included in the sub-band, and a size of indication of the frequency domain resource allocation.

In a seventeenth aspect, alone or in combination with one or more of the first through sixteenth aspects, the indication of the frequency domain resource allocation is included in control information, and wherein a size of the indication in the control information is based on a size of the one or more second frequency domain resources.

In an eighteenth aspect, alone or in combination with one or more of the first through seventeenth aspects, the indication of the frequency domain resource allocation is included in control information, and wherein a size of the indication in the control information is based on a size of the one or more first frequency domain resources.

In a nineteenth aspect, alone or in combination with one or more of the first through eighteenth aspects, the frequency domain resource allocation is based on the BWP, wherein the frequency domain resource allocation is associated with one or more frequency hopping bits, and wherein a quantity of the one or more frequency hopping bits is based on a size of the BWP.

In a twentieth aspect, alone or in combination with one or more of the first through nineteenth aspects, the frequency domain resource allocation is based on the sub-band, wherein the frequency domain resource allocation is associated with one or more frequency hopping bits, and wherein a quantity of the one or more frequency hopping bits is based on a size of the sub-band.

In a twenty-first aspect, alone or in combination with one or more of the first through twentieth aspects, the random access message is received during a time interval of a time interval type, wherein the time interval type is an SBFD type or a non-SBFD type, wherein the frequency domain resource allocation is associated with a frequency hopping offset, and wherein the frequency hopping offset is based on the time interval type.

In a twenty-second aspect, alone or in combination with one or more of the first through twenty-first aspects, the time interval type is the SBFD type, and wherein the frequency hopping offset is based on a quantity of one or more usable frequency domain resources included in the one or more second frequency domain resources.

In a twenty-third aspect, alone or in combination with one or more of the first through twenty-second aspects, the time interval type is the non-SBFD type, and wherein the frequency hopping offset is based on a first size of the BWP or a second size of the sub-band.

In a twenty-fourth aspect, alone or in combination with one or more of the first through twenty-third aspects, the frequency domain resource allocation is associated with a frequency hopping offset, and wherein the frequency hopping offset is based on a first size of the BWP or a second size of the sub-band.

In a twenty-fifth aspect, alone or in combination with one or more of the first through twenty-fourth aspects, receiving the random access message includes receiving the random access message during an SBFD time interval of the SBFD time intervals.

In a twenty-sixth aspect, alone or in combination with one or more of the first through twenty-fifth aspects, receiving the random access message includes receiving the random access message during a non-SBFD time interval.

In a twenty-seventh aspect, alone or in combination with one or more of the first through twenty-sixth aspects, the BWP is an initial BWP.

In a twenty-eighth aspect, alone or in combination with one or more of the first through twenty-seventh aspects, the BWP is an active BWP.

In a twenty-ninth aspect, alone or in combination with one or more of the first through twenty-eighth aspects, the BWP is an uplink BWP, and wherein the sub-band is an uplink sub-band.

In a thirtieth aspect, alone or in combination with one or more of the first through twenty-ninth aspects, the random access message is a first random access message, and wherein the indication of the frequency domain resource allocation is included in a second random access message.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network entity or an apparatus of a network entity. Example process 1200 is an example where the apparatus or the network entity (e.g., the network entity 102, the network entity 106, a UE 220, or the second network entity 610) performs operations associated with an FDRA for a random access message in SBFD scenarios.

As shown in FIG. 12, in some aspects, process 1200 may include receiving first configuration information indicating a sub-band for SBFD time intervals, wherein the sub-band includes one or more first frequency domain resources (block 1210). For example, the network entity (e.g., using reception component 1402 or communication manager 1406, depicted in FIG. 14) may receive first configuration information indicating a sub-band for SBFD time intervals, wherein the sub-band includes one or more first frequency domain resources, as described above.

As further shown in FIG. 12, in some aspects, process 1200 may include receiving second configuration information indicating an active BWP, wherein the active BWP includes one or more second frequency domain resources (block 1220). For example, the network entity (e.g., using reception component 1402 or communication manager 1406, depicted in FIG. 14) may receive second configuration information indicating an active BWP, wherein the active BWP includes one or more second frequency domain resources, as described above.

As further shown in FIG. 12, in some aspects, process 1200 may include receiving an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources (block 1230). For example, the network entity (e.g., using reception component 1402 or communication manager 1406, depicted in FIG. 14) may receive an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources, as described above.

As further shown in FIG. 12, in some aspects, process 1200 may include transmitting, using the frequency domain resource allocation, the random access message (block 1240). For example, the network entity (e.g., using transmission component 1404 or communication manager 1406, depicted in FIG. 14) may transmit, using the frequency domain resource allocation, the random access message, as described above.

Process 1200 may include additional aspects, such as any single aspect or any combination of aspects described below or in connection with one or more other processes described elsewhere herein.

In a first aspect, transmitting the random access message includes transmitting the random access message during a non-SBFD time interval, and wherein the starting frequency domain resource is a first frequency domain resource included in the one or more second frequency domain resources.

In a second aspect, alone or in combination with the first aspect, transmitting the random access message includes transmitting the random access message during a non-SBFD time interval, and wherein the starting frequency domain resource is based on an offset from a first frequency domain resource included in the one or more second frequency domain resources.

In a third aspect, alone or in combination with one or more of the first and second aspects, transmitting the random access message includes transmitting the random access message during a non-SBFD time interval, and wherein the starting frequency domain resource is a first usable frequency resource included in the one or more second frequency domain resources.

In a fourth aspect, alone or in combination with one or more of the first through third aspects, the first usable frequency resource is a first frequency resource included in both the one or more first frequency domain resources and the one or more second frequency domain resources.

In a fifth aspect, alone or in combination with one or more of the first through fourth aspects, a range of the frequency domain numbering is based on a size of an initial BWP.

In a sixth aspect, alone or in combination with one or more of the first through fifth aspects, a range of the frequency domain numbering is based on a size of the one or more first frequency domain resources.

In a seventh aspect, alone or in combination with one or more of the first through sixth aspects, transmitting the random access message includes transmitting the random access message during an SBFD time interval, and wherein the starting frequency domain resource is a first usable frequency resource included in the one or more second frequency domain resources.

In an eighth aspect, alone or in combination with one or more of the first through seventh aspects, the indication of the frequency domain resource allocation is included in control information, and wherein a first size of the indication is based on a second size of an initial BWP.

In a ninth aspect, alone or in combination with one or more of the first through eighth aspects, process 1200 includes determining the frequency domain resource allocation based on the second size.

In a tenth aspect, alone or in combination with one or more of the first through ninth aspects, the frequency domain resource allocation indicates a first frequency domain resource allocation, and wherein determining the frequency domain resource allocation includes determining a second frequency domain resource allocation based on the first frequency domain resource allocation and the second size.

In an eleventh aspect, alone or in combination with one or more of the first through tenth aspects, process 1200 includes determining the frequency domain resource allocation based on a third size of a resource block group for the active BWP.

In a twelfth aspect, alone or in combination with one or more of the first through eleventh aspects, the frequency domain resource allocation indicates a first frequency domain resource allocation, and wherein determining the frequency domain resource allocation includes determining a second frequency domain resource allocation based on the first frequency domain resource allocation and the third size.

In a thirteenth aspect, alone or in combination with one or more of the first through twelfth aspects, the indication of the frequency domain resource allocation is included in control information, and wherein a first size of the indication is based on a second size of the sub-band.

In a fourteenth aspect, alone or in combination with one or more of the first through thirteenth aspects, process 1200 includes determining the frequency domain resource allocation based on the second size.

In a fifteenth aspect, alone or in combination with one or more of the first through fourteenth aspects, the frequency domain resource allocation indicates a first frequency domain resource allocation, and wherein determining the frequency domain resource allocation includes determining a second frequency domain resource allocation based on the first frequency domain resource allocation and the second size.

In a sixteenth aspect, alone or in combination with one or more of the first through fifteenth aspects, process 1200 includes determining the frequency domain resource allocation based on a third size of a resource block group for the active BWP.

In a seventeenth aspect, alone or in combination with one or more of the first through sixteenth aspects, the frequency domain resource allocation indicates a first frequency domain resource allocation, and wherein determining the frequency domain resource allocation includes determining a second frequency domain resource allocation based on the first frequency domain resource allocation and the third size.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network entity or an apparatus of a network entity. Example process 1300 is an example where the apparatus or the network entity (e.g., the network entity 102, the network entity 106, the network node 210, or the first network entity 605) performs operations associated with an FDRA for a random access message in SBFD scenarios.

As shown in FIG. 13, in some aspects, process 1300 may include transmitting first configuration information indicating a sub-band for SBFD time intervals, wherein the sub-band includes one or more first frequency domain resources (block 1310). For example, the network entity (e.g., using transmission component 1504 or communication manager 1506, depicted in FIG. 15) may transmit first configuration information indicating a sub-band for SBFD time intervals, wherein the sub-band includes one or more first frequency domain resources, as described above.

As further shown in FIG. 13, in some aspects, process 1300 may include transmitting second configuration information indicating an active BWP, wherein the active BWP includes one or more second frequency domain resources (block 1320). For example, the network entity (e.g., using transmission component 1504 or communication manager 1506, depicted in FIG. 15) may transmit second configuration information indicating an active BWP, wherein the active BWP includes one or more second frequency domain resources, as described above.

As further shown in FIG. 13, in some aspects, process 1300 may include transmitting an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources (block 1330). For example, the network entity (e.g., using transmission component 1504 or communication manager 1506, depicted in FIG. 15) may transmit an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources, as described above.

As further shown in FIG. 13, in some aspects, process 1300 may include receiving, using the frequency domain resource allocation, the random access message (block 1340). For example, the network entity (e.g., using reception component 1502 or communication manager 1506, depicted in FIG. 15) may receive, using the frequency domain resource allocation, the random access message, as described above.

Process 1300 may include additional aspects, such as any single aspect or any combination of aspects described below or in connection with one or more other processes described elsewhere herein.

In a first aspect, receiving the random access message includes receiving the random access message during a non-SBFD time interval, and wherein the starting frequency domain resource is a first frequency domain resource included in the one or more second frequency domain resources.

In a second aspect, alone or in combination with the first aspect, receiving the random access message includes receiving the random access message during a non-SBFD time interval, and wherein the starting frequency domain resource is based on an offset from a first frequency domain resource included in the one or more second frequency domain resources.

In a third aspect, alone or in combination with one or more of the first and second aspects, receiving the random access message includes receiving the random access message during a non-SBFD time interval, and wherein the starting frequency domain resource is a first usable frequency resource included in the one or more second frequency domain resources.

In a fourth aspect, alone or in combination with one or more of the first through third aspects, the first usable frequency resource is a first frequency resource included in both the one or more first frequency domain resources and the one or more second frequency domain resources.

In a fifth aspect, alone or in combination with one or more of the first through fourth aspects, a range of the frequency domain numbering is based on a size of an initial BWP.

In a sixth aspect, alone or in combination with one or more of the first through fifth aspects, a range of the frequency domain numbering is based on a size of the one or more first frequency domain resources.

In a seventh aspect, alone or in combination with one or more of the first through sixth aspects, receiving the random access message includes receiving the random access message during an SBFD time interval, and wherein the starting frequency domain resource is a first usable frequency resource included in the one or more second frequency domain resources.

In an eighth aspect, alone or in combination with one or more of the first through seventh aspects, the indication of the frequency domain resource allocation is included in control information, and wherein a first size of the indication is based on a second size of an initial BWP.

In a ninth aspect, alone or in combination with one or more of the first through eighth aspects, the frequency domain resource allocation is configured to be based on the second size.

In a tenth aspect, alone or in combination with one or more of the first through ninth aspects, the frequency domain resource allocation is configured to be based on a third size of a resource block group for the active BWP.

In an eleventh aspect, alone or in combination with one or more of the first through tenth aspects, the indication of the frequency domain resource allocation is included in control information, and wherein a first size of the indication is based on a second size of the sub-band.

In a twelfth aspect, alone or in combination with one or more of the first through eleventh aspects, the frequency domain resource allocation is configured to be based on the second size.

In a thirteenth aspect, alone or in combination with one or more of the first through twelfth aspects, the frequency domain resource allocation is configured to be based on a third size of a resource block group for the active BWP.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a network entity, or a network entity may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 114, the communication manager 118, or the communication manager 250. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 110, the processing system 112, or the processing system 240).

In some aspects, the apparatus 1400 may be configured to perform one or more operations described herein in connection with FIG. 6, 7, 8A, 8B, or 9. Additionally, or alternatively, the apparatus 1400 may be configured to perform one or more processes described herein, such as process 1000 of FIG. 10, process 1200 of FIG. 12, or a combination thereof. In some aspects, the apparatus 1400 or one or more components shown in FIG. 14 may include one or more components described in connection with FIGS. 1-2. Additionally, or alternatively, one or more components shown in FIG. 14 may be implemented within one or more components described in connection with FIGS. 1-2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components described above in connection with FIGS. 1-2, such as a radio, one or more RF chains, one or more transceivers, or one or more modems, each of which may in turn be coupled with one or more antennas.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components described above in connection with FIGS. 1-2, such as a radio, one or more RF chains, one or more transceivers, or one or more modems, each of which may in turn be coupled with one or more antennas described in connection with FIGS. 1-2. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The reception component 1402 may receive first configuration information indicating a sub-band for SBFD time intervals, wherein the sub-band includes one or more first frequency domain resources. The reception component 1402 may receive second configuration information indicating a BWP, wherein the BWP includes one or more second frequency domain resources, and wherein the one or more second frequency domain resources are included in the one or more first frequency domain resources based on configuration of the first configuration information. The reception component 1402 may receive an indication of a frequency domain resource allocation for a random access message, wherein the frequency domain resource allocation is based on at least one of the sub-band or the BWP. The transmission component 1404 may transmit, using the frequency domain resource allocation, the random access message.

The reception component 1402 may receive first configuration information indicating a sub-band for SBFD time intervals, wherein the sub-band includes one or more first frequency domain resources. The reception component 1402 may receive second configuration information indicating an active BWP, wherein the active BWP includes one or more second frequency domain resources. The reception component 1402 may receive an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources. The transmission component 1404 may transmit, using the frequency domain resource allocation, the random access message.

The communication manager 1406 may determine the frequency domain resource allocation based on the second size.

The communication manager 1406 may determine the frequency domain resource allocation based on a third size of a resource block group for the active BWP.

The communication manager 1406 may determine the frequency domain resource allocation based on the second size.

The communication manager 1406 may determine the frequency domain resource allocation based on a third size of a resource block group for the active BWP.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a network entity, or a network entity may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 114, the communication manager 118, or the communication manager 255. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 110, the processing system 112, or the processing system 245).

In some aspects, the apparatus 1500 may be configured to perform one or more operations described herein in connection with FIG. 6, 7, 8A, 8B, or 9. Additionally, or alternatively, the apparatus 1500 may be configured to perform one or more processes described herein, such as process 1100 of FIG. 11, process 1300 of FIG. 13, or a combination thereof. In some aspects, the apparatus 1500 or one or more components shown in FIG. 15 may include one or more components described in connection with FIGS. 1-2. Additionally, or alternatively, one or more components shown in FIG. 15 may be implemented within one or more components described in connection with FIGS. 1-2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components described above in connection with FIGS. 1-2, such as a radio, one or more RF chains, one or more transceivers, or one or more modems, each of which may in turn be coupled with one or more antennas.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components described above in connection with FIGS. 1-2, such as a radio, one or more RF chains, one or more transceivers, or one or more modems, each of which may in turn be coupled with one or more antennas described in connection with FIGS. 1-2. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The transmission component 1504 may transmit first configuration information indicating a sub-band for SBFD time intervals, wherein the sub-band includes one or more first frequency domain resources. The transmission component 1504 may transmit second configuration information indicating a BWP, wherein the BWP includes one or more second frequency domain resources, and wherein the one or more second frequency domain resources are included in the one or more first frequency domain resources based on configuration of the first configuration information. The transmission component 1504 may transmit an indication of a frequency domain resource allocation for a random access message, wherein the frequency domain resource allocation is based on at least one of the sub-band or the BWP. The reception component 1502 may receive, using the frequency domain resource allocation, the random access message.

The transmission component 1504 may transmit first configuration information indicating a sub-band for SBFD time intervals, wherein the sub-band includes one or more first frequency domain resources. The transmission component 1504 may transmit second configuration information indicating an active BWP, wherein the active BWP includes one or more second frequency domain resources. The transmission component 1504 may transmit an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources. The reception component 1502 may receive, using the frequency domain resource allocation, the random access message.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a network entity, comprising: receiving first configuration information indicating a sub-band for sub-band full-duplex (SBFD) time intervals, wherein the sub-band includes one or more first frequency domain resources; receiving second configuration information indicating a bandwidth part (BWP), wherein the BWP includes one or more second frequency domain resources, and wherein the one or more second frequency domain resources are included in the one or more first frequency domain resources based on configuration of the first configuration information; receiving an indication of a frequency domain resource allocation for a random access message, wherein the frequency domain resource allocation is based on at least one of the sub-band or the BWP; and transmitting, using the frequency domain resource allocation, the random access message.

Aspect 2: The method of Aspect 1, wherein the one or more first frequency domain resources is the same as the one or more second frequency domain resources.

Aspect 3: The method of any of Aspects 1-2, wherein the one or more second frequency domain resources are a subset of the one or more first frequency domain resources.

Aspect 4: The method of any of Aspects 1-3, wherein the frequency domain resource allocation is based on the sub-band, wherein the frequency domain resource allocation is associated with a frequency domain numbering, and wherein the frequency domain numbering is based on the one or more first frequency domain resources.

Aspect 5: The method of Aspect 4, wherein a range of the frequency domain numbering is based on a quantity of the one or more first frequency domain resources.

Aspect 6: The method of any of Aspects 1-5, wherein the frequency domain resource allocation is based on the BWP, wherein the frequency domain resource allocation is associated with a frequency domain numbering, and wherein the frequency domain numbering is based on the one or more second frequency domain resources.

Aspect 7: The method of Aspect 6, wherein a range of the frequency domain numbering is based on a quantity of the one or more second frequency domain resources.

Aspect 8: The method of any of Aspects 1-5, wherein the frequency domain resource allocation is based on the sub-band, wherein the frequency domain resource allocation is indicated by a resource indication value (RIV), and wherein one or more first values for the RIV are based on the one or more first frequency domain resources.

Aspect 9: The method of Aspect 8, wherein one or more second values for the RIV are based on the one or more second frequency domain resources.

Aspect 10: The method of Aspect 9, wherein the one or more second values are a subset of the one or more first values.

Aspect 11: The method of any of Aspects 1-7, wherein the frequency domain resource allocation is based on the BWP, wherein the frequency domain resource allocation is indicated by a resource indication value, and wherein one or more values for the resource indication value are based on the one or more second frequency domain resources.

Aspect 12: The method of any of Aspects 1-11, wherein the frequency domain resource allocation is indicated by a resource indication value, and wherein the resource indication value uses a resource block group (RBG) granularity.

Aspect 13: The method of Aspect 12, wherein a size of the indication of the frequency domain resource allocation is based on a quantity of one or more RBGs included in the one or more first frequency domain resources.

Aspect 14: The method of Aspect 12, wherein a size of the indication of the frequency domain resource allocation is based on a quantity of one or more RBGs included in the one or more second frequency domain resources.

Aspect 15: The method of any of Aspects 1-14, wherein the frequency domain resource allocation is indicated by a resource indication value, and wherein a size of the resource indication value is greater than 14 bits.

Aspect 16: The method of any of Aspects 1-15, wherein the frequency domain resource allocation is indicated by a resource indication value, and wherein the resource indication value is based on a quantity of one or more hopping bits, a quantity of one or more resource block groups included in the BWP, and a size of indication of the frequency domain resource allocation.

Aspect 17: The method of any of Aspects 1-16, wherein the frequency domain resource allocation is indicated by a resource indication value, and wherein the resource indication value is based on a quantity of one or more hopping bits, a quantity of one or more resource block groups included in the sub-band, and a size of indication of the frequency domain resource allocation.

Aspect 18: The method of any of Aspects 1-17, wherein the indication of the frequency domain resource allocation is included in control information, and wherein a size of the indication in the control information is based on a size of the one or more second frequency domain resources.

Aspect 19: The method of any of Aspects 1-18, wherein the indication of the frequency domain resource allocation is included in control information, and wherein a size of the indication in the control information is based on a size of the one or more first frequency domain resources.

Aspect 20: The method of any of Aspects 1-3, 6-7, and 11-19, wherein the frequency domain resource allocation is based on the BWP, wherein the frequency domain resource allocation is associated with one or more frequency hopping bits, and wherein a quantity of the one or more frequency hopping bits is based on a size of the BWP.

Aspect 21: The method of any of Aspects 1-5, 8-10, and 12-19, wherein the frequency domain resource allocation is based on the sub-band, wherein the frequency domain resource allocation is associated with one or more frequency hopping bits, and wherein a quantity of the one or more frequency hopping bits is based on a size of the sub-band.

Aspect 22: The method of any of Aspects 1-21, wherein transmitting the random access message comprises transmitting the random access message during a time interval of a time interval type, wherein the time interval type is an SBFD type or a non-SBFD type, wherein the frequency domain resource allocation is associated with a frequency hopping offset, and wherein the frequency hopping offset is based on the time interval type.

Aspect 23: The method of Aspect 22, wherein the time interval type is the SBFD type, and wherein the frequency hopping offset is based on a quantity of one or more usable frequency domain resources included in the one or more second frequency domain resources.

Aspect 24: The method of Aspect 22, wherein the time interval type is the non-SBFD type, and wherein the frequency hopping offset is based on a first size of the BWP or a second size of the sub-band.

Aspect 25: The method of any of Aspects 1-24, wherein the frequency domain resource allocation is associated with a frequency hopping offset, and wherein the frequency hopping offset is based on a first size of the BWP or a second size of the sub-band.

Aspect 26: The method of any of Aspects 1-25, wherein transmitting the random access message comprises transmitting the random access message during an SBFD time interval of the SBFD time intervals.

Aspect 27: The method of any of Aspects 1-26, wherein transmitting the random access message comprises transmitting the random access message during a non-SBFD time interval.

Aspect 28: The method of any of Aspects 1-27, wherein the BWP is an initial BWP.

Aspect 29: The method of any of Aspects 1-27, wherein the BWP is an active BWP.

Aspect 30: The method of any of Aspects 1-29, wherein the BWP is an uplink BWP, and wherein the sub-band is an uplink sub-band.

Aspect 31: The method of any of Aspects 1-30, wherein the random access message is a first random access message, and wherein the indication of the frequency domain resource allocation is included in a second random access message.

Aspect 32: A method of wireless communication performed by a network entity, comprising: transmitting first configuration information indicating a sub-band for sub-band full-duplex (SBFD) time intervals, wherein the sub-band includes one or more first frequency domain resources; transmitting second configuration information indicating a bandwidth part (BWP), wherein the BWP includes one or more second frequency domain resources, and wherein the one or more second frequency domain resources are included in the one or more first frequency domain resources based on configuration of the first configuration information; transmitting an indication of a frequency domain resource allocation for a random access message, wherein the frequency domain resource allocation is based on at least one of the sub-band or the BWP; and receiving, using the frequency domain resource allocation, the random access message.

Aspect 33: The method of Aspect 32, wherein the one or more first frequency domain resources and the one or more second frequency domain resources are the same.

Aspect 34: The method of any of Aspects 32-33, wherein the one or more second frequency domain resources are a subset of the one or more first frequency domain resources.

Aspect 35: The method of any of Aspects 32-34, wherein the frequency domain resource allocation is based on the sub-band, wherein the frequency domain resource allocation is associated with a frequency domain numbering, and wherein the frequency domain numbering is based on the one or more first frequency domain resources.

Aspect 36: The method of Aspect 35, wherein a range of the frequency domain numbering is based on a quantity of the one or more first frequency domain resources.

Aspect 37: The method of any of Aspects 32-36, wherein the frequency domain resource allocation is based on the BWP, wherein the frequency domain resource allocation is associated with a frequency domain numbering, and wherein the frequency domain numbering is based on the one or more second frequency domain resources.

Aspect 38: The method of Aspect 37, wherein a range of the frequency domain numbering is based on a quantity of the one or more second frequency domain resources.

Aspect 39: The method of any of Aspects 32-36, wherein the frequency domain resource allocation is based on the sub-band, wherein the frequency domain resource allocation is indicated by a resource indication value (RIV), and wherein one or more first values for the RIV are based on the one or more first frequency domain resources.

Aspect 40: The method of Aspect 39, wherein one or more second values for the RIV are based on the one or more second frequency domain resources.

Aspect 41: The method of Aspect 40, wherein the one or more second values are a subset of the one or more first values.

Aspect 42: The method of any of Aspects 32-38, wherein the frequency domain resource allocation is based on the BWP, wherein the frequency domain resource allocation is indicated by a resource indication value, and wherein one or more values for the resource indication value are based on the one or more second frequency domain resources.

Aspect 43: The method of any of Aspects 32-42, wherein the frequency domain resource allocation is indicated by a resource indication value, and wherein the resource indication value using a resource block group (RBG) granularity.

Aspect 44: The method of Aspect 43, wherein a size of the indication of the frequency domain resource allocation is based on a quantity of one or more RBGs included in the one or more first frequency domain resources.

Aspect 45: The method of Aspect 43, wherein a size of the indication of the frequency domain resource allocation is based on a quantity of one or more RBGs included in the one or more second frequency domain resources.

Aspect 46: The method of any of Aspects 32-45, wherein the frequency domain resource allocation is indicated by a resource indication value, and wherein a size of the resource indication value is greater than 14 bits.

Aspect 47: The method of any of Aspects 32-46, wherein the frequency domain resource allocation is indicated by a resource indication value, and wherein the resource indication value is based on a quantity of one or more hopping bits, a quantity of one or more resource block groups included in the BWP, and a size of indication of the frequency domain resource allocation.

Aspect 48: The method of any of Aspects 32-47, wherein the frequency domain resource allocation is indicated by a resource indication value, and wherein the resource indication value is based on a quantity of one or more hopping bits, a quantity of one or more resource block groups included in the sub-band, and a size of indication of the frequency domain resource allocation.

Aspect 49: The method of any of Aspects 32-48, wherein the indication of the frequency domain resource allocation is included in control information, and wherein a size of the indication in the control information is based on a size of the one or more second frequency domain resources.

Aspect 50: The method of any of Aspects 32-49, wherein the indication of the frequency domain resource allocation is included in control information, and wherein a size of the indication in the control information is based on a size of the one or more first frequency domain resources.

Aspect 51: The method of any of Aspects 32-40, 37-38, and 42-50, wherein the frequency domain resource allocation is based on the BWP, wherein the frequency domain resource allocation is associated with one or more frequency hopping bits, and wherein a quantity of the one or more frequency hopping bits is based on a size of the BWP.

Aspect 52: The method of any of Aspects 32-36, 39-41, and 43-50, wherein the frequency domain resource allocation is based on the sub-band, wherein the frequency domain resource allocation is associated with one or more frequency hopping bits, and wherein a quantity of the one or more frequency hopping bits is based on a size of the sub-band.

Aspect 53: The method of any of Aspects 32-52, wherein the random access message is received during a time interval of a time interval type, wherein the time interval type is an SBFD type or a non-SBFD type, wherein the frequency domain resource allocation is associated with a frequency hopping offset, and wherein the frequency hopping offset is based on the time interval type.

Aspect 54: The method of Aspect 53, wherein the time interval type is the SBFD type, and wherein the frequency hopping offset is based on a quantity of one or more usable frequency domain resources included in the one or more second frequency domain resources.

Aspect 55: The method of Aspect 53, wherein the time interval type is the non-SBFD type, and wherein the frequency hopping offset is based on a first size of the BWP or a second size of the sub-band.

Aspect 56: The method of any of Aspects 32-55, wherein the frequency domain resource allocation is associated with a frequency hopping offset, and wherein the frequency hopping offset is based on a first size of the BWP or a second size of the sub-band.

Aspect 57: The method of any of Aspects 32-56, wherein receiving the random access message comprises receiving the random access message during an SBFD time interval of the SBFD time intervals.

Aspect 58: The method of any of Aspects 32-57, wherein receiving the random access message comprises receiving the random access message during a non-SBFD time interval.

Aspect 59: The method of any of Aspects 32-58, wherein the BWP is an initial BWP.

Aspect 60: The method of any of Aspects 32-58, wherein the BWP is an active BWP.

Aspect 61: The method of any of Aspects 32-60, wherein the BWP is an uplink BWP, and wherein the sub-band is an uplink sub-band.

Aspect 62: The method of any of Aspects 32-61, wherein the random access message is a first random access message, and wherein the indication of the frequency domain resource allocation is included in a second random access message.

Aspect 63: A method of wireless communication performed by a network entity, comprising: receiving first configuration information indicating a sub-band for sub-band full-duplex (SBFD) time intervals, wherein the sub-band includes one or more first frequency domain resources; receiving second configuration information indicating an active bandwidth part (BWP), wherein the active BWP includes one or more second frequency domain resources; receiving an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; and transmitting, using the frequency domain resource allocation, the random access message.

Aspect 64: The method of Aspect 63, wherein transmitting the random access message comprises transmitting the random access message during a non-SBFD time interval, and wherein the starting frequency domain resource is a first frequency domain resource included in the one or more second frequency domain resources.

Aspect 65: The method of any of Aspects 63-64, wherein transmitting the random access message comprises transmitting the random access message during a non-SBFD time interval, and wherein the starting frequency domain resource is based on an offset from a first frequency domain resource included in the one or more second frequency domain resources.

Aspect 66: The method of any of Aspects 63-65, wherein transmitting the random access message comprises transmitting the random access message during a non-SBFD time interval, and wherein the starting frequency domain resource is a first usable frequency resource included in the one or more second frequency domain resources.

Aspect 67: The method of Aspect 66, wherein the first usable frequency resource is a first frequency resource included in both the one or more first frequency domain resources and the one or more second frequency domain resources.

Aspect 68: The method of any of Aspects 63-67, wherein a range of the frequency domain numbering is based on a size of an initial BWP.

Aspect 69: The method of any of Aspects 63-68, wherein a range of the frequency domain numbering is based on a size of the one or more first frequency domain resources.

Aspect 70: The method of any of Aspects 63-69, wherein transmitting the random access message comprises transmitting the random access message during an SBFD time interval, and wherein the starting frequency domain resource is a first usable frequency resource included in the one or more second frequency domain resources.

Aspect 71: The method of any of Aspects 63-70, wherein the indication of the frequency domain resource allocation is included in control information, and wherein a first size of the indication is based on a second size of an initial BWP.

Aspect 72: The method of Aspect 71, further comprising: determining the frequency domain resource allocation based on the second size.

Aspect 73: The method of Aspect 72, wherein the frequency domain resource allocation indicates a first frequency domain resource allocation, and wherein determining the frequency domain resource allocation comprises determining a second frequency domain resource allocation based on the first frequency domain resource allocation and the second size.

Aspect 74: The method of Aspect 71, further comprising determining the frequency domain resource allocation based on a third size of a resource block group for the active BWP.

Aspect 75: The method of Aspect 74, wherein the frequency domain resource allocation indicates a first frequency domain resource allocation, and wherein determining the frequency domain resource allocation comprises determining a second frequency domain resource allocation based on the first frequency domain resource allocation and the third size.

Aspect 76: The method of any of Aspects 63-75, wherein the indication of the frequency domain resource allocation is included in control information, and wherein a first size of the indication is based on a second size of the sub-band.

Aspect 77: The method of Aspect 76, further comprising: determining the frequency domain resource allocation based on the second size.

Aspect 78: The method of Aspect 77, wherein the frequency domain resource allocation indicates a first frequency domain resource allocation, and wherein determining the frequency domain resource allocation comprises determining a second frequency domain resource allocation based on the first frequency domain resource allocation and the second size.

Aspect 79: The method of Aspect 74, further comprising: determining the frequency domain resource allocation based on a third size of a resource block group for the active BWP.

Aspect 80: The method of Aspect 79, wherein the frequency domain resource allocation indicates a first frequency domain resource allocation, and wherein determining the frequency domain resource allocation comprises determining a second frequency domain resource allocation based on the first frequency domain resource allocation and the third size.

Aspect 81: A method of wireless communication performed by a network entity, comprising: transmitting first configuration information indicating a sub-band for sub-band full-duplex (SBFD) time intervals, wherein the sub-band includes one or more first frequency domain resources; transmitting second configuration information indicating an active bandwidth part (BWP), wherein the active BWP includes one or more second frequency domain resources; transmitting an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; and receiving, using the frequency domain resource allocation, the random access message.

Aspect 82: The method of Aspect 81, wherein receiving the random access message comprises receiving the random access message during a non-SBFD time interval, and wherein the starting frequency domain resource is a first frequency domain resource included in the one or more second frequency domain resources.

Aspect 83: The method of any of Aspects 81-82, wherein receiving the random access message comprises receiving the random access message during a non-SBFD time interval, and wherein the starting frequency domain resource is based on an offset from a first frequency domain resource included in the one or more second frequency domain resources.

Aspect 84: The method of any of Aspects 81-83, wherein receiving the random access message comprises receiving the random access message during a non-SBFD time interval, and wherein the starting frequency domain resource is a first usable frequency resource included in the one or more second frequency domain resources.

Aspect 85: The method of Aspect 84, wherein the first usable frequency resource is a first frequency resource included in both the one or more first frequency domain resources and the one or more second frequency domain resources.

Aspect 86: The method of any of Aspects 81-85, wherein a range of the frequency domain numbering is based on a size of an initial BWP.

Aspect 87: The method of any of Aspects 81-86, wherein a range of the frequency domain numbering is based on a size of the one or more first frequency domain resources.

Aspect 88: The method of any of Aspects 81-87, wherein receiving the random access message comprises receiving the random access message during an SBFD time interval, and wherein the starting frequency domain resource is a first usable frequency resource included in the one or more second frequency domain resources.

Aspect 89: The method of any of Aspects 81-88, wherein the indication of the frequency domain resource allocation is included in control information, and wherein a first size of the indication is based on a second size of an initial BWP.

Aspect 90: The method of Aspect 89, wherein the frequency domain resource allocation is configured to be based on the second size.

Aspect 91: The method of Aspect 89, wherein the frequency domain resource allocation is configured to be based on a third size of a resource block group for the active BWP.

Aspect 92: The method of any of Aspects 81-91, wherein the indication of the frequency domain resource allocation is included in control information, and wherein a first size of the indication is based on a second size of the sub-band.

Aspect 93: The method of Aspect 92, wherein the frequency domain resource allocation is configured to be based on the second size.

Aspect 94: The method of Aspect 92, wherein the frequency domain resource allocation is configured to be based on a third size of a resource block group for the active BWP.

Aspect 95: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-94.

Aspect 96: An apparatus for wireless communication at a device, the apparatus comprising one or more memories and one or more processors coupled to the one or more memories, the one or more processors configured to cause the device to perform the method of one or more of Aspects 1-94.

Aspect 97: An apparatus for wireless communication, the apparatus comprising at least one means for performing the method of one or more of Aspects 1-94.

Aspect 98: A non-transitory computer-readable medium storing code for wireless communication, the code comprising instructions executable by one or more processors to perform the method of one or more of Aspects 1-94.

Aspect 99: A non-transitory computer-readable medium storing a set of instructions for wireless communication, the set of instructions comprising one or more instructions that, when executed by one or more processors of a device, cause the device to perform the method of one or more of Aspects 1-94.

Aspect 100: A device for wireless communication, the device comprising a processing system that includes one or more processors and one or more memories coupled with the one or more processors, the processing system configured to cause the device to perform the method of one or more of Aspects 1-94.

Aspect 101: An apparatus for wireless communication at a device, the apparatus comprising one or more memories and one or more processors coupled to the one or more memories, the one or more processors individually or collectively configured to cause the device to perform the method of one or more of Aspects 1-94.

Aspect 102: A device comprising a processing system that includes one or more processors and one or more code-storing memories coupled with the one or more processors, the processing system configured to cause the device to perform the method of one or more of Aspects 1-94.

Aspect 103: A device comprising a processing system that includes processor circuitry and code-storing memory circuitry, the processing system configured to cause the device to perform the method of one or more of Aspects 1-94.

Aspect 104: A device for wireless communication, the device comprising a processing system, the processing system configured to perform the method of one or more of Aspects 1-94.

Aspect 105: A non-transitory computer-readable medium having code thereon that, when executed by a device, causes the device to perform the method of one or more of Aspects 1-94.

Systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network entity, comprising:
a processing system configured to:
receive first configuration information indicating a sub-band for sub-band full-duplex (SBFD) time intervals, wherein the sub-band includes one or more first frequency domain resources;
receive second configuration information indicating an active bandwidth part (BWP), wherein the active BWP includes one or more second frequency domain resources;
receive an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; and
transmit, using the frequency domain resource allocation, the random access message.

2. The network entity of claim 1, wherein, to transmit the random access message, the processing system is configured to transmit the random access message during a non-SBFD time interval, and wherein the starting frequency domain resource is a first frequency domain resource included in the one or more second frequency domain resources.

3. The network entity of claim 1, wherein, to transmit the random access message, the processing system is configured to transmit the random access message during a non-SBFD time interval, and wherein the starting frequency domain resource is based on an offset from a first frequency domain resource included in the one or more second frequency domain resources.

4. The network entity of claim 1, wherein, to transmit the random access message, the processing system is configured to transmit the random access message during a non-SBFD time interval, and wherein the starting frequency domain resource is a first usable frequency resource included in the one or more second frequency domain resources.

5. The network entity of claim 1, wherein a range of the frequency domain numbering is based on a size of an initial BWP.

6. The network entity of claim 1, wherein a range of the frequency domain numbering is based on a size of the one or more first frequency domain resources.

7. The network entity of claim 1, wherein, to transmit the random access message, the processing system is configured to transmit the random access message during an SBFD time interval, and wherein the starting frequency domain resource is a first usable frequency resource included in the one or more second frequency domain resources.

8. The network entity of claim 1, wherein the indication of the frequency domain resource allocation is included in control information, and wherein a first size of the indication is based on a second size of an initial BWP.

9. The network entity of claim 8, wherein the processing system is configured to determine the frequency domain resource allocation based on the second size.

10. The network entity of claim 9, wherein the frequency domain resource allocation indicates a first frequency domain resource allocation, and wherein, to determine the frequency domain resource allocation, the processing system is configured to determine a second frequency domain resource allocation based on the first frequency domain resource allocation and the second size.

11. The network entity of claim 8, wherein the processing system is configured to determine the frequency domain resource allocation based on a third size of a resource block group for the active BWP.

12. The network entity of claim 11, wherein the frequency domain resource allocation indicates a first frequency domain resource allocation, and wherein, to determine the frequency domain resource allocation, the processing system is configured to determine a second frequency domain resource allocation based on the first frequency domain resource allocation and the third size.

13. The network entity of claim 1, wherein the indication of the frequency domain resource allocation is included in control information, and wherein a first size of the indication is based on a second size of the sub-band.

14. A network entity, comprising:
a processing system configured to:
transmit first configuration information indicating a sub-band for sub-band full-duplex (SBFD) time intervals, wherein the sub-band includes one or more first frequency domain resources;
transmit second configuration information indicating an active bandwidth part (BWP), wherein the active BWP includes one or more second frequency domain resources;
transmit an indication of a frequency domain resource allocation for a random access message, wherein the frequency domain resource allocation is included in the one or more second frequency domain resources, wherein the frequency domain resource allocation is based on frequency domain numbering starting from a starting frequency domain resource, and wherein the starting frequency domain resource is based on at least one of the one or more first frequency domain resources or the one or more second frequency domain resources; and
receive, using the frequency domain resource allocation, the random access message.

15. The network entity of claim 14, wherein, to receive the random access message, the processing system is configured to receive the random access message during a non-SBFD time interval, and wherein the starting frequency domain resource is a first frequency domain resource included in the one or more second frequency domain resources.

16. The network entity of claim 14, wherein, to receive the random access message, the processing system is configured to receive the random access message during a non-SBFD time interval, and wherein the starting frequency domain resource is based on an offset from a first frequency domain resource included in the one or more second frequency domain resources.

17. The network entity of claim 14, wherein, to receive the random access message, the processing system is configured to receive the random access message during a non-SBFD time interval, and wherein the starting frequency domain resource is a first usable frequency resource included in the one or more second frequency domain resources.

18. The network entity of claim 17, wherein the first usable frequency resource is a first frequency resource included in both the one or more first frequency domain resources and the one or more second frequency domain resources.

19. The network entity of claim 14, wherein a range of the frequency domain numbering is based on a size of an initial BWP.

20. The network entity of claim 14, wherein a range of the frequency domain numbering is based on a size of the one or more first frequency domain resources.
